(19) United States
(12) Patent Application Publication
(10) Pub. No.: US 2025/0074833 A1
(43) Pub. Date: Mar. 6, 2025

(54) Liquid Salt Composition and Methods of Making and Using Same

(71) Applicant: Halliburton Energy Services, Inc., Houston, TX (US)

(72) Inventors: Rahul Jadhav, Stavanger (NO); Gunnar Lende, Stavanger (NO)

(21) Appl. No.: 18/240,031

(22) Filed: Aug. 30, 2023

(51) Int. Cl. C04B 40/00; C04B 14/10; C04B 14/30; C04B 22/12; C04B 22/14; C04B 24/38; C04B 28/04; C09K 8/467

(52) U.S. Cl. CPC C04B 40/0039; C04B 14/10; C04B 14/304; C04B 22/124; C04B 22/147; C04B 24/383; C04B 28/04; C09K 8/467; C04B 2103/0093; C04B 2103/10

(57) ABSTRACT

A liquid salt composition for a cementitious slurry, the liquid salt composition comprising one or more salts, one or more suspending aids, glycol, and water. The one or more salts are present in the liquid salt composition in an amount of from about 5 wt % to about 95 wt %, based on the total weight of the liquid salt composition. A method of utilizing the cementitious slurry comprising the liquid salt composition for servicing a wellbore penetrating a subterranean formation is also provided.

### FIELD

This application relates to the recovery of natural resources from a wellbore penetrating a subterranean formation, and more specifically this application relates to a liquid composition that can be used in wellbore servicing fluids.

### BACKGROUND

This disclosure relates generally to a liquid composition. More specifically, it relates to a liquid salt composition and using of the liquid salt composition in a wellbore servicing fluid for treating a wellbore penetrating a subterranean formation, for example during a cementing operation.

Natural resources such as gas, oil, and water residing in a subterranean formation are usually recovered by drilling a wellbore down to the subterranean formation while circulating a drilling fluid, also referred to as drilling mud, in the wellbore. After terminating circulation of the drilling fluid, a string of pipe, e.g., casing, is run in the wellbore. The drilling fluid is then usually circulated downward through the interior of the pipe and upward through the annulus, which is located between the exterior of the pipe and the walls of the wellbore. Next, primary cementing is typically performed whereby a cement slurry is placed in the annulus and permitted to set into a hard mass (i.e., sheath) to thereby attach the string of pipe to the walls of the wellbore and seal the annulus. Subsequent secondary cementing operations may also be performed. One example of a secondary cementing operation is squeeze cementing whereby a cement slurry is employed to plug and seal off undesirable flow passages in the cement sheath and/or the casing.

While cement slurries have been developed heretofore, challenges continue to exist with the successful use of cement slurries in subterranean cementing operations. For example, one challenge in well cementing is the development of satisfactory mechanical properties in a cement slurry within a desired time period. Oftentimes additives are added to cement slurries to meet the requirements. Therefore, an ongoing need exists for an additive that can be prepared, stored, and added to a cement slurry to control setting time of the cement slurry and resulting properties of the set/hardened cement produced therefrom.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 depicts an example system for the preparation and delivery of a cementitious composition to a wellbore in accordance with embodiments of this disclosure;

FIG. 2 is schematic of the placement of a cementitious composition into a wellbore annulus in accordance with embodiments of this disclosure;

FIG. 3 is a flow chart of example methods in accordance with embodiments of this disclosure;

FIG. 4A depicts the liquid salt composition (LSC) of Example 1 in a bottle;

FIG. 4B depicts the LSC of Example 1 in the graduated cylinder on day 0 after placement in the graduated cylinder;

FIG. 4C depicts the LSC of Example 1 in the graduated cylinder on day 7 of the stability test;

FIG. 5 is a plot of the data from Example 6, showing the effect of accelerators on thickening time (TT) and UCA in a 14.19 lbₘ/gal cement slurry;

FIG. 6 is a plot using data from Example 6, showing the effect of the various accelerators on 24 hr UCA and crush strength at 50° F.;

FIG. 7 is a plot of the data from Example 7, showing average of five thickening time (TT) time to 50 Bearden units of consistency (BC) and UCA time to 500 psi tests comparison in the 13.35 lbₘ/gal cement slurry;

FIG. 8 is a plot using data from Example 7, showing the UCA and crush strength comparison in the 13.35 lbₘ/gal cement slurry;

FIG. 9 is a plot of the data from Example 8, showing the effect of the LSC concentration on the thickening time (TT) time to 50 BC and UCA time to 500 psi in the 13.35 lbₘ/gal cement slurry; and

FIG. 10 is a plot using data from Example 8, showing the effect of the LSC concentration on 24 hour strength (e.g., 24 hr UCA and 24 hr crush strength) in the 13.35 lbₘ/gal cement slurry.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

It is to be understood that “subterranean formation” encompasses both areas below exposed earth and areas below earth covered by water such as ocean or fresh water. Herein in the disclosure, “top” means the well at the surface (e.g., at the wellhead which may be located on dry land or below water, e.g., a subsea wellhead), and the direction along a wellbore towards the well surface is referred to as “up”; “bottom” means the end of the wellbore away from the surface, and the direction along a wellbore away from the wellbore surface is referred to as “down.” For example, in a horizontal wellbore, two locations may be at the same level (i.e., depth within a subterranean formation), the location closer to the well surface (by comparing the lengths along the wellbore from the wellbore surface to the locations) is referred to as “above” the other location, the location farther away from the well surface (by comparing the lengths along the wellbore from the wellbore surface to the locations) is referred to as “below” or “lower than” the other location.

Conventional set accelerators can be liquid in form, and (a) reduce thickening time and (b) increase early compressive strength development after set. Such accelerators can be considered “total accelerators”. For typical top hole/surface casing job applications (e.g., in which a bottom-hole temperature is between 50-70° F.), short setting time and rapid strength development may be sought.

To achieve early compressive strength, additional amounts of accelerators can be added, but, at the same time, thickening time also shortens accordingly. Thus, a “partial accelerator” that would increase early strength without significantly altering the thickening time may be desired in some applications. Such a partial accelerator is provided herein.

It has been unexpectedly discovered that salt or combination of salts in combination can provide strength improvement when used in a neat cement or cement blend (e.g., a low carbon dioxide (CO₂) footprint cement blend). Since the salts are in powder form, they can be dry blended with other blend components; however, by locking them in the blend operational flexibility can be lost. For example, when the blend is utilized for applications where temperature is above 140° F., early strength development might not be an issue, and, to compensate the accelerator in the blend, more retarder may be required. It has been discovered that providing the salts in usable liquid form, as described hereinbelow, enables utilization of the resulting liquid salt solution offshore (or elsewhere) without losing operational flexibility.

Accordingly, disclosed herein is a liquid salt composition (e.g., also referred to herein as an “LSC”, a “liquid salt accelerator” (LSA), or a “liquid salt solution”; and the term “salts” or “salt” can also be utilized for the combination of one or more salts) comprising one or more salts, a suspending aid, glycol, and water. The liquid salt composition can be referred to herein as an “accelerator”, or as a “strength development accelerator” as it can increase the rate of early strength development without greatly altering thickening time or time of first set. The liquid salt composition can be in a form of fluid (e.g., a suspension, a slurry). In embodiments, the one or more salts are present in the liquid salt composition in an amount of from about 5 wt % to about 95 wt %, based on the total weight of the liquid salt composition, alternatively from about 10 wt % to about 80 wt %, alternatively from about 20 wt % to about 80 wt %, alternatively from about 30 wt % to about 80 wt %, alternatively from about 40 wt % to about 75 wt %, alternatively from about 50 wt % to about 70 wt %, alternatively from about 40 wt % to about 70 wt %, or alternatively from about 50 wt % to about 55 wt %. In embodiments, the one or more salts are present in the liquid salt composition in an amount of from about 40 wt % to about 60 wt % based on the total weight of the liquid salt composition. In embodiments, the one or more salts are present in the liquid salt composition in an amount of from about 45 wt % to about 55 wt % based on the total weight of the liquid salt composition. In embodiments, the one or more salts are present in the liquid salt composition in an amount of from about 50 wt % to about 60 wt % based on the total weight of the liquid salt composition.

The salt in the liquid salt composition can be any suitable salt. In embodiments, the salt comprises chloride, sulfate, phosphate, bromide, bicarbonate, acetate, formate, and carbonate salts of lithium, potassium, sodium, calcium, magnesium, zinc, iron, or combinations thereof. Without being limited by theory, a portion of the salt can be dissolved in the water in the liquid salt composition, and at least a portion of the salt can be suspended in the water with help of the suspending aid. In embodiments, the salt comprises a first salt and a second salt, for example and without limitation, sodium chloride and sodium sulfate. The weight ratio of the first salt to the second salt can be from about 1:9 to about 9:1, alternatively from about 1:9 to about 5:1, alternatively from about 1:5 to about 5:1, alternatively from about 1:3 to about 3:1, or alternatively from about 1:2 to about 2:1.

As noted above, the liquid salt composition can comprise a suspending aid. A suspending aid is a substance that is added to fluids to promote particle suspension or dispersion and reduce sedimentation. Without being limited by theory, the suspending aid disclosed herein can promote suspension of at least a portion of the one or more salts.

The suspending aid can be any suitable material. In embodiments, the suspending aid comprises one or more synthetic polymers (e.g., a polyacrylamide, a cellulose derivative, or a combination thereof), one or more biopolymers (e.g., a cellulose, Xanthan, scleroglucan polysaccharides, or a combination thereof), one or more clays, or a combination thereof. Examples of cellulose derivatives suitable for use in the present disclosure include without limitation carboxyethylcellulose, carboxymethylcellulose, carboxymethylhydroxyethylcellulose, alkylhydroxyalkylcellulose, alkycellulose, alkylcarboxy-alkylcellulose, hydroxyethylcellulose, and other hydroxyalkylcelluloses. In embodiments, the suspending aid comprises a water-soluble polymer. Herein a “water-soluble polymer” is defined as a polymer that dissolves, disperses, or swells in water, with a solubility of equal to or greater than about 0.01 wt % based on the total weight of the polymer and water at about 70° F. In embodiments, the suspending aid comprises a polyacrylamide-based polymer.

In embodiments, the suspending aid comprises a polymer polymerized from monomers selected from the group consisting of vinyl pyrrolidone, 2-Acrylamido-2-methyl propane sulfonic acid (AMPS), acrylamide, N,N-dimethylacrylamide (NNDMA), N-vinylacetamide, allyloxy-2-hydroxy propane sulfonic acid (AHPS), acrylic acid (AA), 2-acrylamido-2-tert.-butyl sulfonic acid (ATBS), N,N-dimethylaniline, pentaerythritol allyl ether, methylenebisacrylamide, divinyl ether, diallyl ether, vinyl ethers of polyglycols, vinyl ethers of polyols, allyl ethers of polyglycols, allyl ethers of polyols, divinylbenzene, 1,3-divinylimidazolidin-2-one, divinyltetrahydropyrimidin-2 (1H)-one, dienes, allyl amines, N-vinyl-3 (E)-ethylidene pyrrolidone, ethylidene bis(N-vinylpyrrolidone), N-substituted acrylamides, methacrylamide, N-substituted methacrylamides, acrylates, methacrylates, methacrylic acid, N-vinylamides, N-allyl amides, vinyl alcohol, vinyl ethers, vinyl esters, allyl alcohol, allyl ethers, allyl esters, vinylpyridine, vinyl sulfonates, allyl sulfonates, vinylimidazole, allylimidazole, diallyldimethylammonium chloride, epichlorohydrin, epichhalohydrin, diepoxides, dialdehydes, trimethyolpropane triacrylate, pentaerythritol tetraacrylate, divinyl sulphone, carbodiimide, glutraldehyde, acryloylmorpholine, N-vinyl-N-methylaceamide, N-vinylformamide, N-vinylpyrrolidone, acrylonitrile, acrylomorpholine, maleic anhydride, and combinations thereof. In embodiments, the suspending aid comprises a copolymer of AMPS.

In embodiments, the suspending aid comprises a clay. A variety of clays can be employed, such as, for example, bentonite clay, sepiolite clay, attapulgite clay, hectorite clay, water swellable synthetic clays, or a combination thereof. In embodiments, the suspending aid comprises a synthetic clay. In embodiments, the LSC comprises from greater than 0 to about 10 wt % clay, from about 0.1, 0.2, 0.3, 0.5, or 0.5 to about 1, 2, 3, 4, 5, 6, 7, 8, 9, or 10 wt % clay.

In embodiments, the suspending aid comprises a polymer (e.g., a water-soluble polymer), such as, without limitation, Diutan gum, xanthan gum, wellan gum, guar gum, modified guar gum, hydroxy ethyl cellulose, modified cellulose, other classes of polysaccharides, or combinations thereof. In embodiments, the LSC comprises a polymer (e.g., a biopolymer) in a range of from greater than 0 to about 10 wt %, or from about 0.1, 0.2, 0.3, 0.4, or 0.5 wt % to about 1, 2, 3, 4, 5, 6, 7, 8, 9, or 10 wt %.

In embodiments, the suspending aid comprises a synthetic clay and a water-soluble polymer.

The suspending aid can have an average molecular weight of from equal to or greater than about 50,000, 100,000, 500,000, 1,000,000, 2,000,000 Daltons (Da) to equal to or less than about 6,000,000 Da, alternatively from equal to or greater than about 3,000,000 Da to equal to or less than about 6,000,000 Da, alternatively from equal to or greater than about 2,00,000 Da to equal to or less than about 5,000,000 Da, alternatively from equal to or greater than about 3,000,000 Da to equal to or less than about 4,000,000 Da, alternatively from equal to or greater than about 2,500,000 Da to equal to or less than about 3,000,000 Da, or alternatively from equal to or greater than about 2,000,000 Da to equal to or less than about 4,000,000 Da. The suspending aid can be present in the liquid salt composition in an amount of from about 0.05 wt % to about 20.0 wt %, based on the total weight of the liquid salt composition, alternatively from about 0.05 wt % to about 15.0 wt %, alternatively from about 0.05 wt % to about 10.0 wt %, alternatively from about 0.05 wt % to about 7.0 wt %, alternatively from about 0.05 wt % to about 5.0 wt %, alternatively from about 0.5 wt % to about 5.0 wt %, alternatively from about 0.5 wt % to about 4.0 wt %, or alternatively from about 0.5 wt % to about 1.5 wt %. In embodiments, the suspending aid is present in the liquid salt composition in an amount of from about 0.5 wt % to about 3.0 wt % based on the total weight of the liquid salt composition. In embodiments, the suspending aid is present in the liquid salt composition in an amount of from about 0.5 wt % to about 2.0 wt % based on the total weight of the liquid salt composition. In embodiments, the suspending aid is present in the liquid salt composition in an amount of from about 0.5 wt % to about 0.8 wt % based on the total weight of the liquid salt composition.

The liquid salt composition comprises glycol. The glycol can comprise a C1-C4, a C1-C5, and/or a C1-C6 glycol (e.g., a glycol comprising from 1 to 4 carbons, from 1 to 5 carbons, or from 1 to 6 carbons). In embodiments, the glycol comprises mono-ethylene glycol (MEG; also known as 1,2-ethanediol), monopropylene glycol (MPG; also known as 1,2-propanediol), dipropylene glycol (DPG); triethylene glycol (TEG); butylene glycol (also known as butanediol, e.g., 1,3-butylene glycol (1,3-butanediol) or 1,4-butylene glycol (1,4-butanediol)), or a combination thereof. In embodiments, the glycol comprises from about 50 to about 100, from about 60 to about 100, or from about 70 to about 100 volume percent MEG, based on the total volume of the glycol. In embodiments, the glycol component of the LSC comprises greater than about 50, 60, 70, 80, 90, or 100 volume percent glycol and the balance water.

In embodiments, the glycol is present in the liquid salt composition in an amount of from greater than 0 to about 95 wt %, from about 0.1 to about 95 wt %, from about 1 wt % to about 50 wt %, from about 5 to about 35 wt %, from about 5 to about 25 wt %, from about 5 to about 20 wt %, from about 5 to about 15 wt %, based on the total weight of the liquid salt composition. In embodiments, the glycol is present in the liquid salt composition in a range having a lower endpoint of about 1, 2, 3, 4, 5, 6, 7, 8, 9, 9.5, or 10 wt % and an upper end point of about 50, 45, 40, 35, 30, 25, 20, 15, 14, 13, 12, 11, or 10 wt %.

The liquid salt composition can comprise water. Generally, the water may be from any source, provided that it does not contain an amount of components that may undesirably affect the other components in the liquid salt composition. For example, the water can be selected from a group consisting essentially of fresh water, surface water, ground water, produced water, salt water, sea water, brine (e.g., underground natural brine, formulated brine, etc.), and combinations thereof. A formulated brine may be produced by dissolving one or more soluble salts in water, a natural brine, or seawater. Representative soluble salts include the chloride, bromide, acetate, and formate salts of potassium, sodium, calcium, magnesium, and zinc. The water can be present in the liquid salt composition in an amount effective to provide a slurry having desired (e.g., job or service specific) rheological properties. In embodiments, the water is present in the liquid salt composition in an amount of from greater than 0 to about 95 wt5, from about 5 wt % to about 95 wt %, based on the total weight of the liquid salt composition, alternatively from about 10 wt % to about 75 wt %, alternatively from about 15 wt % to about 60 wt %, alternatively from about 20 wt % to about 50 wt %, alternatively from about 25 wt % to about 45 wt %, or alternatively from about 30 wt % to about 40 wt %.

In embodiments, the LSC comprises a biocide, such as a preservative/bactericide, in a range of from greater than 0 to about 1 wt %, such as from about 0.01, 0.02, 0.03, 0.04, or 0.05 wt % to about 0.1, 0.2, 0.3, 0.4, 0.5 wt %.

In embodiments, the LSC comprises a buffer (e.g., magnesium oxide, MgO), in a range of from greater than 0 to about 1 wt %, or from about 0.01, 0.02, 0.03, 0.04, or 0.05 wt % to about 0.1, 0.2, 0.3, 0.4, 0.5, 0.6, 0.7, 0.8, 0.9, or 1 wt %.

A liquid salt composition of the type disclosed herein can be prepared using any suitable method. In embodiments, the method comprises placing components of the liquid salt composition (e.g., a salt, water) into a suitable container (e.g., a mixer, a blender) and blending to form a pumpable slurry (e.g., a homogeneous fluid). The container can be any container that is compatible with the components of the liquid salt composition and has sufficient space. A blender or mixer can be used for blending/mixing the components of the liquid salt composition. After preparation, the liquid salt composition can be stored in the container or a storage container.

The liquid salt composition disclosed herein can have any suitable density, including, but not limited to, in a range of from about 9 lb/gal (ppg) to about 20 ppg, alternatively from about 10 ppg to about 18 ppg, alternatively from about 11 ppg to about 16 ppg, or alternatively from about 12 ppg to about 14 ppg.

The liquid salt composition can have free fluid in a range of from about 0 vol. % to about 10 vol. % based on the total volume of the liquid salt composition, alternatively from about 0 vol. % to about 8 vol. %, alternatively from about 0 vol. % to about 5 vol. %, or alternatively from about 0 vol. % to about 4 vol. %, after being static at about 70° F. for about 1 week to about 7 weeks from preparation of the liquid salt composition. Free fluid refers to a fluid that separates from a fluid body that contains major amounts of salt after the liquid salt composition is prepared and kept static for a certain period of time.

In one or more embodiments, the liquid salt composition may be included in a cementitious composition (also sometimes referred to herein simply as a “composition”) comprising a cementitious material, an aqueous fluid, and the liquid salt composition.

In some examples, the main components present in the cementitious composition may consist essentially of the cementitious (e.g., hydraulic) material, the pozzolanic material, and optionally aplite. For example, the main components (e.g., of the dry blend) may primarily comprise (consist essentially of or consist of) the cementitious (e.g., hydraulic) material, the pozzolanic material, and the aplite (e.g., without any or without substantial additional components that hydraulically set in the presence of water.

The cementitious material in the cementitious composition may comprise a hydraulic cement that sets and hardens by reaction with water. Examples of hydraulic cements include but are not limited to Portland cements (e.g., classes A, B, C, G, and H Portland cements), pozzolana cements, gypsum cements, phosphate cements, high alumina content cements, silica cements, high alkalinity cements, acid/base cements, magnesia cements such as Sorel cements, micro-fine cement, and combinations thereof.

In embodiments, the cementitious composition comprises a cement composition adapted to contain the LSC of this disclosure, such as a cement composition described in U.S. patent application Ser. No. 16/479,023 entitled, “Accelerators for Composite Cement Compositions” or Ser. No. 17/509,756 entitled, “A Low Carbon Footprint Expansive Composition and Methods of Making and Using Same,” the disclosures of each of which are herein incorporated in their entirety for purposes not contrary to this disclosure.

In embodiments, the cementitious composition comprises the cementitious material, a pozzolanic material, aplite, the aqueous fluid, and the liquid salt composition. Herein a “cementitious material” refers to a settable material that makes up a concrete mixture. As noted hereinabove, in embodiments, the cementitious material comprises a hydraulic cement. In other embodiments, the cementitious material can be based on pozzolans, minerals and activators, and not contain any hydraulic cement.

As noted above, the cementitious material can comprise a hydraulic material A variety of hydraulic cements may be utilized in accordance with the present disclosure, including, but not limited to, those comprising calcium, aluminum, silicon, oxygen, iron, and/or sulfur, which set and harden by reaction with water. Suitable hydraulic cements may include, but are not limited to, Portland cements, pozzolana cements, gypsum cements, high alumina content cements, silica cements, and any combination thereof. In embodiments, the cementitious material comprises a “high alumina content cement”, which refers to a cement having an alumina concentration in the range of from about 40 wt % to about 80 wt % by a weight of the high alumina content cement. Silica cement can be formed when phosphoric acid displaces metal ions from an alumina-silica glass, containing metal oxides and fluorides. In embodiments, the cementitious material comprises a Portland cement. Portland cements can for oilfield applications be classified as Classes A, C, H, and G cements according to American Petroleum Institute, API Specification for Materials and Testing for Well Cements, API Specification 10. Fifth Ed., Jul. 1, 1990. In addition, hydraulic cements may include cements classified by American Society for Testing and Materials (ASTM) in C150 (Standard Specification for Portland Cement), C595 (Standard Specification for Blended Hydraulic Cement) or C1157 (Performance Specification for Hydraulic Cements) such as those cements classified as ASTM Type I, II, III, IV, or V. Portland cements that are suited for use in the disclosed composition include, but are not limited to, API Class A, C, G, H, low sulfate resistant cements, medium sulfate resistant cements, high sulfate resistant cements, other construction cements, or combinations thereof. The API class A, C, G, and H cements are classified according to API Specification 10A. Additional examples of Portland cements suitable for use in the present disclose include, without limitation, those classified as ASTM Type I, II, III, IV, or V. In embodiments, the cementitious material comprises a class C or equivalent cement. In embodiments, the cementitious material comprises a class G cement.

The cementitious material (e.g., the hydraulic cement) may be included in the cementitious composition in any amount suitable for a particular application. The cementitious material can be present in the composition in an amount of from about 1 weight percent by weight of blend (% bwob) to about 90% bwob based on the total weight of a cement blend comprising the cementitious material, and the pozzolanic material, and optionally aplite. Alternatively, the cementitious material can be present in the composition in an amount of from about 10% bwob to about 80% bwob, alternatively from about 20% bwob to about 70% bwob, alternatively from about 30% bwob to about 60% bwob, or alternatively from about 40% bwob to about 50% bwob.

Without limitation, the hydraulic cement may be included in the cementitious composition in an amount in the range of from about 10% to about 80% by weight of dry blend (% bwob) of the cementitious composition. For example, the hydraulic cement may be present in an amount ranging between any of and/or including any of about 10%, about 15%, about 20%, about 25%, about 30%, about 35%, about 40%, about 45%, about 50%, about 55%, about 60%, about 65%, about 70%, about 75%, or about 80% by weight of dry blend of the cementitious composition.

The pozzolanic material can comprise a material selected from the group consisting of Trass flour, recycled glass, fly ash, bottom ash, cenospheres, glass bubbles, slag, clays, calcined clays, partially calcined clays, kaolinite clays, lateritic clays, illite clays, crystalline silica, silica flour, cement kiln dust, volcanic rock, natural pozzolans, mine tailings, diatomaceous earth, zeolite, shale, ground vitrified pipe, agricultural waste ash, ground granulated blast furnace slag, bentonite, pumice, and any combination thereof.

In embodiments, the pozzolanic material comprises Trass flour. The Trass flour is from Trass, which is the name of a volcanic tuff. Trass is a grey or cream-colored fragmental rock, largely composed of pumiceous dust, and may be regarded as a trachytic tuff. Trass can have similar ingredients as Italian pozzolana. In embodiments, the Trass flour has a d50 particle size distribution of equal to or less than about 50 microns, alternatively equal to or less than about 25 microns, alternatively equal to or less than about 15 microns, alternatively equal to or less than about 5 microns, alternatively equal to or less than about 1 micron, or alternatively equal to or less than about 0.1 micron.

In embodiments, the pozzolanic material comprises pumice. Pumice is a type of extrusive volcanic rock, produced when lava with water and gases is discharged from a volcano. In other embodiments, the pozzolanic material comprises calcined clay, which can be formed by heating clay at high temperatures (e.g., equal to or greater than 1200° F.). In other embodiments, the pozzolanic material comprises ground granulated blast furnace slag, which can be produced by quenching molten iron slag from a blast furnace in water or steam, to produce product that is then dried and ground into a fine powder. In other embodiments, the pozzolanic material comprises fly ash, which can be a byproduct of coal-fired or wood-fired electric generating plants. In embodiments, the pozzolanic material comprises bentonite.

The pozzolanic material can be present in the composition in an amount of from about 1% bwob to about 90% bwob based on the total weight of the cement blend. Alternatively, the pozzolanic material can be present in the composition in an amount of from about 5% bwob to about 80% bwob, alternatively from about 10% bwob to about 70% bwob, alternatively from about 10% bwob to about 60% bwob, alternatively from about 15% bwob to about 50% bwob, or alternatively from about 15% bwob to about 35% bwob.

Aplite refers to any intrusive igneous rock of simple composition, such as granite, composed only of alkali feldspar, muscovite mica, and quartz; in a more restricted sense, uniformly fine-grained (e.g., less than 2 millimeters [0.08 inch]), light-colored, intrusive igneous rocks that have a characteristic granular texture. In embodiments, the aplite comprises granite. The granite can be in a form of granite powder. The aplite can be present in the composition in an amount of from about 1% bwob to about 90% bwob based on the total weight of the cement blend. Alternatively, the aplite can be present in the composition in an amount of from about 5% bwob to about 80% bwob, alternatively from about 10% bwob to about 70% bwob, alternatively from about 10% bwob to about 60% bwob, alternatively from about 15% bwob to about 50% bwob, or alternatively from about 15% bwob to about 35% bwob. In embodiments, the aplite comprises granite and the pozzolanic material comprises Trass flour. In embodiments, the aplite comprises granite and the pozzolanic material comprises pumice. In embodiments, the aplite comprises granite and the pozzolanic material comprises calcined clay. In embodiments, the aplite comprises granite and the pozzolanic material comprises ground granulated blast furnace slag. In embodiments, the aplite comprises granite and the pozzolanic material comprises fly ash. In embodiments, the aplite comprises granite and the pozzolanic material comprises bentonite.

The aplite may be included in the cementitious composition in any amount suitable for a particular application. Without limitation, the aplite may be included in the cementitious composition in an amount in the range of from about 10% to about 80% by weight of dry blend (% bwob) of the cementitious composition. For example, the aplite may be present in an amount ranging between any of and/or including any of about 10%, about 15%, about 20%, about 25%, about 30%, about 35%, about 40%, about 45%, about 50%, about 55%, about 60%, about 65%, about 70%, about 75%, or about 80% by weight of dry blend of the cementitious composition.

As noted hereinabove, the cementitious composition can comprise an aqueous fluid. Generally, the aqueous fluid may be from any source, provided that it does not contain an amount of components that may undesirably affect the other components in the cementitious composition. For example, the aqueous fluid can be selected from fresh water, surface water, ground water, produced water, salt water, sea water, brine (e.g., underground natural brine, formulated brine, etc.), or combinations thereof. A formulated brine may be produced by dissolving one or more soluble salts in water, a natural brine, or seawater. Representative soluble salts include the chloride, bromide, acetate, and formate salts of potassium, sodium, calcium, magnesium, and zinc. The aqueous fluid can be present in the cementitious composition in an amount effective to provide a slurry having desired (e.g., job or service specific) rheological properties. In embodiments, the aqueous fluid is present in the cementitious composition in an amount effective to form a pumpable slurry of the cementitious composition. In embodiments, the aqueous fluid is present in the cementitious composition in an amount of from about 33% to about 200% based on the total weight of dry blend of the cementitious composition, alternatively from about 40% to about 200%, or alternatively from about 50% to about 200% by weight of dry blend of the cementitious composition.

In embodiments, the cementitious composition further comprises silica fume. In embodiments, the silica fume is a component of the cement blend, and the cement blend comprises the cementitious material, the pozzolanic material, the aplite, and the silica fume. The silica fume can be present in the composition in an amount of from about 0.5% bwob to about 50% bwob based on the total weight of the cement blend. Alternatively, the silica fume can be present in the composition in an amount of from about 0.5% bwob to about 40% bwob, alternatively from about 1% bwob to about 30% bwob, alternatively from about 1% bwob to about 20% bwob, or alternatively from about 1% bwob to about 10% bwob. The silica fume can also be included in the composition in the form of a liquid, in such embodiments the silica fume is added to a fluid (e.g., the liquid phase) of the composition instead of being a part of the cement blend. In embodiments, the silica fume is in forms of both a solid and a liquid and is added to the cement blend and the fluid, respectively.

In embodiments, the cementitious composition comprises the cementitious material, the pozzolanic material, the silica fume, the LSC, and the aqueous fluid, wherein the pozzolanic material comprises Trass flour. In embodiments, the cementitious composition comprises the cementitious material, the pozzolanic material, the silica fume, the LSC, and the aqueous fluid, wherein the pozzolanic material comprises fly ash. In embodiments, the cementitious composition comprises the cementitious material, the pozzolanic material, aplite, the silica fume, the LSC, and the aqueous fluid, wherein the pozzolanic material comprises Trass flour and the aplite comprises granite. In embodiments, the cementitious composition comprises the cementitious material, the pozzolanic material, aplite, the silica fume, the LSC, and the aqueous fluid, wherein the pozzolanic material comprises fly ash and the aplite comprises granite. In embodiments, the cementitious composition comprises the cementitious material, the pozzolanic material, aplite, the silica fume, the LSC, and the aqueous fluid, wherein the cementitious material comprises a Portland cement, the pozzolanic material comprises Trass flour, and the aplite comprises granite.

The cementitious composition comprises the LSC of this disclosure, as detailed hereinabove. The LSC comprises one or more salts, a suspending aid, glycol, and water, wherein the one more salts are present in the liquid salt composition in an amount of from about 5 wt % to about 95 wt %. For example, in embodiments, the LSC comprises a first salt and a second salt (e.g., in a 1:1 wt ratio, such as, without limitation, about 20-30 wt % of each salt, based on the total weight of the liquid salt composition).

The LSC can be present in the cementitious composition in an amount of from about 0.001 wt % to about 50 wt % based on the total weight of the cementitious composition, alternatively from about 0.5 wt % to about 50 wt %, or alternatively from about 5 wt % to about 50 wt %. In embodiments, the LSC can be present in the cementitious composition in an amount of from about 0.2% to about 50% by weight of dry blend (% bwob) of the cementitious composition, alternatively from about 5% to about 50%, alternatively from about 10% to about 50%, or alternatively from about 10% to about 45%. The dry blend of the cementitious composition, also referred to as a dry blend of cementitious components, can include the cementitious material (e.g., a hydraulic cement, such as Portland cement), the pozzolanic material, the aplite, and any additional dry materials (e.g., a supplementary cementitious material, and other cementitious materials (e.g., hydrated lime)). As detailed hereinabove, the LSC can operate as an accelerator. The first salt can be present in the cementitious composition in an amount ranging from about 0.1 to about 10, from about 0.15 to about 5, or from about 0.2 to about 2 wt %, based on the total weight of the cementitious composition. The second salt can be present in the cementitious composition in an amount ranging from about 0.1 to about 10, from about 0.15 to about 5, or from about 0.2 to about 2 wt %, based on the total weight of the cementitious composition. In embodiments, a molar ratio of the first salt to the second salt in the cementitious composition can be in a range of from about 1:10 to about 10:1, alternatively from about 1:5 to about 5:1, or alternatively from about 1:2 to about 2:1. Via this disclosure, the first salt and the second salt are added to the cementitious composition in the form of a liquid (e.g., as components of the liquid salt composition).

In embodiments, the cementitious composition excludes an expansion additive. In other embodiments the cementitious composition includes an expansion additive. For example, an expansion additive can be present in the composition in an amount of equal to or less than about 10% bwob based on the total weight of the cement blend, alternatively equal to or less than about 5% bwob, alternatively from about 0.5% bwob to about 4% bwob, or alternatively equal to or less than about 0.001% bwob

In embodiments, the composition further comprises a stabilizing agent and/or viscosifier. The stabilizing agent can be added in a form of liquid or powder. The pre-blended stabilizing agent can comprise bentonite, sepiolite, attapulgite, water swellable synthetic clays, Diutan gum, xanthan gum, wellan gum, guar gum, modified guar gum, hydroxy ethyl cellulose, modified cellulose, other classes of polysaccharides, or combinations thereof. In embodiments, the pre-blended stabilizing agent is prepared before making the composition. The pre-blended stabilizing agent can be present in the composition in an amount ranging from about 0.01% bwob to about 10% bwob based on the total weight of the cement blend, alternatively from about 0.05% bwob to about 6% bwob, or alternatively from about 0.1% bwob to about 3% bwob.

In embodiments, the cementitious composition further comprises limestone, hydrated lime, or both. In such embodiments, the limestone is a component of the cement blend. Limestone is a type of carbonate sedimentary rock. Limestone can be composed mostly of minerals calcite and aragonite, which are different crystal forms of calcium carbonate. In embodiments, limestone is present in the cementitious composition in an amount ranging from about 0.01% bwob to about 90% bwob based on the total weight of the cement blend, alternatively from about 0.05% bwob to about 50% bwob, or alternatively from about 0.1% bwob to about 30% bwob.

In examples, the cementitious composition may further include hydrated lime. As used herein, the term “hydrated lime” will be understood to mean calcium hydroxide. In embodiments, the hydrated lime may be provided as quicklime (calcium oxide) which hydrates when mixed with water to form the hydrated lime. The hydrated lime may be included in examples of the cementitious composition, for example, to form a hydraulic composition with the supplementary cementitious material. Where present, the hydrated lime may be included in the set cementitious composition in an amount in the range of from about 10% to about 100% by weight of dry blend of the cementitious composition, for example. In some examples, the hydrated lime may be present in an amount ranging between any of and/or including any of about 10%, about 20%, about 40%, about 60%, about 80%, or about 100% by weight of dry blend of the cementitious composition.

The cementitious composition can further comprise a supplementary cementitious material. The supplementary cementitious material can be selected from the group consisting of fly ash, blast furnace slag, silica fume, pozzolans, kiln dust, clays, volcanic ash, and combinations thereof.

The cementitious composition may include supplementary cementitious materials. The supplementary cementitious material may be any material that contributes to the compressive strength of the cementitious composition when set (the “set cement”). Some supplementary cementitious materials may include, without limitation, fly ash, blast furnace slag, silica fume, pozzolans, kiln dust, and clays, for example. Although only some supplementary cementitious materials are disclosed herein, one of ordinary skill in the art, with the benefit of this disclosure, should be able to readily recognize if a material may be suitable to include in a cementitious composition as a supplementary cementitious material.

For example, the cementitious composition may include kiln dust as a supplementary cementitious material. “Kiln dust,” as that term is used herein, refers to a solid material generated as a by-product of the heating of certain materials in kilns. The term “kiln dust” as used herein is intended to include kiln dust made as described herein and equivalent forms of kiln dust. Depending on its source, kiln dust may exhibit cementitious properties in that it can set and harden in the presence of water. Examples of suitable kiln dusts include cement kiln dust, lime kiln dust, and combinations thereof. Cement kiln dust may be generated as a by-product of cement production that is removed from the gas stream and collected, for example, in a dust collector. Usually, large quantities of cement kiln dust are collected in the production of cement that are commonly disposed of as waste. The chemical analysis of the cement kiln dust from various cement manufactures varies depending on a number of factors, including the particular kiln feed, the efficiencies of the cement production operation, and the associated dust collection systems. Cement kiln dust generally may include a variety of oxides, such as SiO₂, Al₂O₃, Fe₂O₃, CaO, MgO, SO₃, Na₂O, and K₂O. The chemical analysis of lime kiln dust from various lime manufacturers varies depending on several factors, including the particular limestone or dolomitic limestone feed, the type of kiln, the mode of operation of the kiln, the efficiencies of the lime production operation, and the associated dust collection systems. Lime kiln dust generally may include varying amounts of free lime and free magnesium, lime stone, and/or dolomitic limestone and a variety of oxides, such as SiO₂, Al₂O₃, Fe₂O₃, CaO, MgO, SO₃, Na₂O, and K₂O, and other components, such as chlorides. A cement kiln dust may be added to the cementitious composition prior to, concurrently with, or after activation (e.g., combination of the dry blend with the LSC/aqueous fluid). Cement kiln dust may include a partially calcined kiln feed which is removed from the gas stream and collected in a dust collector during the manufacture of cement. The chemical analysis of CKD from various cement manufactures varies depending on a number of factors, including the particular kiln feed, the efficiencies of the cement production operation, and the associated dust collection systems. CKD generally may comprise a variety of oxides, such as SiO₂, Al₂O₃, Fe₂O₃, CaO, MgO, SO₃, Na₂O, and K₂O. The CKD and/or lime kiln dust may be included in examples of the cementitious composition in an amount suitable for a particular application.

In some examples, the cementitious composition may further include one or more of slag, natural glass, shale, amorphous silica, or metakaolin as a supplementary cementitious material. Slag is generally a granulated, blast furnace by-product from the production of cast iron including the oxidized impurities found in iron ore. The cementitious composition may further include perlite. Perlite is an ore and generally refers to a naturally occurring volcanic, amorphous siliceous rock including mostly silicon dioxide and aluminum oxide. The perlite may be expanded and/or unexpanded as suitable for a particular application. The expanded or unexpanded perlite may also be ground, for example. The cementitious composition may further include shale. A variety of shales may be suitable, including those including silicon, aluminum, calcium, and/or magnesium. Examples of suitable shales include vitrified shale and/or calcined shale.

In some examples, the cementitious composition may further include amorphous silica as a supplementary cementitious material. Amorphous silica is a powder that may be included in embodiments to increase cement compressive strength. Amorphous silica is generally a byproduct of a ferrosilicon production process, wherein the amorphous silica may be formed by oxidation and condensation of gaseous silicon suboxide, SiO, which is formed as an intermediate during the process.

In some examples, the cementitious composition may further include a variety of fly ashes as a supplementary cementitious material which may include fly ash classified as Class C, Class F. or Class N fly ash according to American Petroleum Institute, API Specification for Materials and Testing for Well Cements, API Specification 10, Fifth Ed., Jul. 1, 1990. In some examples, the cementitious composition may further include zeolites as supplementary cementitious materials. Zeolites are generally porous alumino-silicate minerals that may be either natural or synthetic Synthetic zeolites are based on the same type of structural cell as natural zeolites and may comprise aluminosilicate hydrates As used herein, the term “zeolite” refers to all natural and synthetic forms of zeolite.

Where used, one or more of the aforementioned supplementary cementitious materials may be present in the cementitious composition. For example, without limitation, one or more supplementary cementitious materials may be present in an amount of about 0.1% to about 80% by weight of dry blend (% bwob) of the cementitious composition. For example, the perlite may be present in an amount ranging between any of and/or including any of about 0.1%, about 10%, about 20%, about 30%, about 40%, about 50%, about 60%, about 70%, or about 80% by weight of dry blend of the cementitious composition.

In embodiments, the cementitious composition further comprises one or more additives. The one or more additives can comprise weighting agents, retarders, accelerators, activators, gas migration control additives, lightweight additives, gas-generating additives, mechanical-property-enhancing additives (e.g., carbon fibers, glass fibers, metal fibers, minerals fibers, polymeric elastomers, latexes, etc.), lost-circulation materials, filtration-control additives, fluid-loss-control additives, defoaming agents, foaming agents, transition time modifiers, dispersants, thixotropic additives, suspending agents, or combinations thereof. One having ordinary skill in the art, with the benefit of this disclosure, should be able to select one or more appropriate additives for a particular application. The one or more additives can be present in the composition in any suitable amounts. For example, the one or more additives can be present in the cementitious composition in an amount ranging from about 0.01% bwob to about 50% bwob based on the total weight of the cement blend, alternatively from about 0.05% bwob to about 40% bwob, alternatively from about 0.1% bwob to about 30% bwob, alternatively from about 1% bwob to about 20% bwob, or alternatively from about 1% bwob to about 10% bwob.

In embodiments, when added thereto, the LSC of this disclosure serves to activate the cementitious composition (e.g., when the LSC and water added to a dry blend comprising the cementitious material, the pozzolanic material, and optionally the aplite, and optional additional dry materials, the cementitious composition begins the setting process). In embodiments, the cementitious composition can be characterized as being able to be stored in a pumpable fluid state for at least one day (e.g., at least about 1 day, about 2 weeks, 1 month, or more) at room temperature (e.g., about 70° F.) in quiescent storage optionally with addition of a suitable retarder A fluid is considered to be in a pumpable fluid state where the fluid has a consistency of less than 70 Bearden units of consistency (“Be”), as measured on a pressurized consistometer in accordance with the procedure for determining cement thickening times set forth in API RP Practice 10B-2, Recommended Practice for Testing Well Cements, First Edition, July 2005.

Once activated (e.g., by combination with aqueous fluid and/or the LSC disclosed herein), the cementitious composition will proceed to set into a hardened mass. Like “accelerator”, the term “cement set activator” or “activator”, as used herein, can refer to the LSC, that may activate the cementitious composition such that the strength increases faster after the cementitious composition sets to form a hardened mass (e.g., not necessarily accelerating the initial strength timing, but accelerating the growth of strength).

The cementitious composition disclosed herein can have any suitable density, including, but not limited to, in a range of from about 500 kg/m³ to about 3,000 kg/m³, alternatively from about 800 km/m³ to about 2,800 kg/m³, alternatively from about 1,200 kg/m³ to about 2,800 kg/m³, alternatively from about 1,200 kg/m³ to about 2,600 kg/m³, or alternatively from about 1,300 kg/m³ to about 2,100 kg/m³.

The composition can have a positive 7-day circumferential change in dimension in a range of from about 0.01% to about 2% at from about 20° C./68° F. to about 150° C./302° F., alternatively from about 0.05% to about 1%, alternatively from about 0.05% to about 0.8%, alternatively from about 0.05% to about 0.4%, or alternatively from about 0.05% to about 0.2%, when measured in a ring expansion test in accordance with test standard API 10B-5 on Determination of shrinkage or expansion under conditions of free access of water at atmospheric pressure—Annular ring test. The time is 7 days after mixing.

The composition can have a positive 14-day circumferential change in dimension in a range of from about 0.01% to about 2% at from about 20° C./68° F. to about 150° C./302° F., alternatively from about 0.05% to about 1%, alternatively from about 0.05% to about 0.8%, alternatively from about 0.05% to about 0.4%, or alternatively from about 0.05% to about 0.2%, when measured in a ring expansion test in accordance with test standard API 10B-5. The time is 14 days after mixing in the aqueous fluid. The expansion (e.g., a positive 7-day circumferential change, 14-day circumferential change) can be increased by including a standard expansion material (e.g., an expansion additive) in the cementitious composition when a higher expansion is desired.

In embodiments, the cementitious composition has a thickening time. The thickening time herein can refer to the time required for the cementitious composition to achieve 50 Bearden units of Consistency (Bc) after preparation of the cementitious composition. At about 50 Bc, the cementitious composition undergoes a conversion from a pumpable fluid state to a non-pumpable gel. The thickening time can be an important design factor as the cementitious composition may be pumped thousands of meters through conduit and may take hours to place. Other values can be used to define the thickening time too, such as 30, 40, 70 or 100 Bc. In order to keep the cementitious composition in a pumpable state for an appropriate amount of time, additives such as retarders and accelerators can be added to modulate the pump time by shortening or extending the thickening time. A measurement of Bearden units of Consistency (Bc) can be considered a thickening time test which is performed on a moving fluid. In a thickening time test, an apparatus including a pressurized consistometer can apply temperature and pressure to a slurry (e.g., a composition) while the slurry is being stirred by a paddle. A resistor arm and potentiometer coupled to the paddle can provide an output in Volt DC, units which is converted to Bearden units of consistency.

In embodiments, the cementitious composition has a thickening time to reach about 50 Bc in a range of from about 2.0 hours to about 20.0 hours at about 50° F., alternatively from about 2.0 hours to about 18.0 hours, alternatively from about 2.0 hours to about 15.0 hours, alternatively from about 3.0 hours to about 10.0 hours, when measured in accordance with test standard API-RP-10B-2.

In embodiments, the cementitious composition has a thickening time to reach about 50 Bc in a range of from about 2.0 hours to about 20.0 hours at about 68° F., alternatively from about 3.0 hours to about 18.0 hours, alternatively from about 3.0 hours to about 14.0 hours, alternatively from about 3.0 hours to about 9.0 hours, alternatively from about 3.0 hours to about 8.0 hours, alternatively from about 3.0 hours to about 7.0 hours, when measured in accordance with test standard API-RP-10B-2.

Compressive strength is generally the capacity of a material or structure to withstand axially directed compression forces. The compressive strength of a composition can be measured at a specified time (e.g., 24 hours) after a cement blend has been mixed with water and the resultant cement slurry is maintained under specified temperature and pressure conditions to form a hardened, set cement. For example, compressive strength can be measured at a time in the range of from about 12 to about 48 hours (or longer) after the cement slurry is mixed, and the cement slurry is maintained typically at a temperature of from 0° C./32° F. to about 204° C./400° F. and a suitable pressure, during which time the cement slurry can set into a hardened mass. Compressive strength can be measured by either a destructive method or non-destructive method. The destructive method physically tests the strength of hardened samples at various points in time by crushing the samples in a compression-testing machine. The compressive strength is calculated from the failure load divided by the cross-sectional area resisting the load and is reported in units of pound-force per square inch (psi). Non-destructive methods can employ an ultrasonic cement analyzer (UCA). A UCA can be available from FANN® Instrument Company, Houston, TX. Compressive strengths can be determined in accordance with API RP 10B-2, Recommended Practice for Testing Well Cements, First Edition, July 2005.

In embodiments, the cementitious composition has a time to reach 50 psi (345 kPa) compressive strength (also referred to as “time to reach 50 psi”) measured in an ultrasonic cement analyzer (UCA) test in accordance with test standard API-RP-10B-2. The time to reach 50 psi under static conditions in a UCA can be used as an estimation of the initial set time of a composition. The time to reach 50 psi can be the time it takes for a cement slurry to transition from a pumpable fluid state to a hardened set state.

In embodiments, the cementitious composition has a time to reach 50 psi compressive strength in a range of from about 2.0 hours to about 24.0 hours at about 20° C./68° F. to about 150° C./302° F. in a UCA test, alternatively from about 2.0 hours to about 20.0 hours, alternatively from about 2.0 hours to about 18.0 hours, alternatively from about 3.0 hours to about 15.0 hours, or alternatively from about 3.0 hours to about 10.0 hours, when measured in accordance with test standard API-RP-10B-2.

In embodiments, the cementitious composition has a 24-hour compressive strength (also referred to as “24-hour crush strength” or “24-hour crush compressive strength”) measured in accordance with test standard API-RP-10B-2. The 24-hour compressive strength can be in a range of from about 50 psi to about 10,000 psi at from about 10° C./50° F. to about 80° C./176° F. in a UCA test, alternatively from about 100. psi to about 7,500 psi, alternatively from about 200. psi to about 5,500 psi, alternatively from about 250 psi to about 3,500 psi, alternatively from about 300 psi to about 2,500 psi, or alternatively from about 300 psi to about 2,000 psi. The time is 24-hour period after mixing the cement blend with the liquid components (e.g., the aqueous fluid, LSC, or combination thereof).

In embodiments, the cementitious composition has a 28-day compressive strength (also referred to as “28-day crush strength” or “28-day crush compressive strength”) measured in accordance with test standard API-RP-10B-2. The 28-day compressive strength can be in a range of from about 50 psi to about 10,000 psi at from about 80° C./176° F. to about 150° C./302° F. in a UCA test, alternatively from about 100 psi to about 10,000 psi, alternatively from about 200 psi to about 7,500 psi, alternatively from about 250 psi to about 5,500 psi, alternatively from about 300 psi to about 3,500 psi, alternatively from about 300 psi to about 2,500 psi, or alternatively from about 300 psi to about 1,500 psi. The time is 28-day period after mixing the cement blend with water.

The cementitious composition can have a stable or increasing compressive strength as time increases from about 1 week to about 6 weeks, at a temperature between about 0° C./32° F. to about 110° C./230° F. in an ultrasonic cement analyzer (UCA) test when measured in accordance with test standard API-RP-10B-2.

In embodiments, the cementitious composition has a 7-day unconfined compressive strength (UCS) of from about 200 psi to about 5,000 psi at from about 20° C./68° F. to about 150° C./302° F. when measured in accordance with test standard ASTM D7012-14e1, alternatively from about 700 psi to about 5,000 psi, alternatively from about 800 psi to about 4,000 psi, alternatively from about 800 psi to about 3,000 psi, or alternatively from about 900 psi to about 3,000 psi. The unconfined compressive strength, is the maximum stress that a set composition can endure when confining pressure is zero. It can be measured using a destructive method, where the maximum stress recorded at failure is the unconfined compressive strength, also referred to as the unconfined crush strength or crush compressive strength. 7-day unconfined compressive strength can be measured after 7 days from preparation of the composition.

In embodiments, the cementitious composition has a 7-day tensile strength (TS) of from about 25 psi to about 1,000 psi at from about 20° C./68° F. to about 150° C./302° F. when measured in accordance with test standard ASTM D3967-16, alternatively from about 70 psi to about 750 psi, alternatively from about 100 psi to about 550 psi, alternatively from about 100 psi to about 500 psi, or alternatively from about 200 psi to about 500 psi. Tensile strength is also referred to as Brazilian Tensile Strength. Tensile strength is generally the capacity of a material to withstand loads tending to elongate, as opposed to compressive strength. The tensile strength of the cementitious composition may be measured at a specified time (e.g., 7 days) after the other components (e.g., the cement blend and LSC) have been mixed with water and the resultant composition is maintained under specified temperature and pressure conditions. For example, tensile strength can be measured at 7 days after the cementitious composition is mixed and the cementitious composition is maintained at a temperature of from 10° C./50° F. to about 204° C./400° F. and a suitable pressure. Tensile strength may be measured using any suitable method, including without limitation in accordance with the procedure described in ASTM C307. That is, specimens may be prepared in briquette molds having the appearance of dog biscuits with a one square inch cross-sectional area at the middle. Tension may then be applied at the enlarged ends of the specimens until the specimens break at the center area. The tension in pounds per square inch at which the specimen breaks is the tensile strength of the material tested.

In embodiments, the cementitious composition has a 7-day Young's modulus (YM) of from about 2 GPa to about 14 GPa at from about 20° C./68° F. to about 150° C./302° F., alternatively from about 3 GPa to about 10 GPa, alternatively from about 3 GPa to about 9 GPa, alternatively from about 3 GPa to about 8 GPa, or alternatively from about 4 GPa to about 8 GPa. Young's modulus also referred to as the modulus of elasticity is a measure of the relationship of an applied stress to the resultant strain. In general, a highly deformable (plastic) material will exhibit a lower modulus when the confined stress is increased. Thus, the Young's modulus is an elastic constant that demonstrates the ability of the tested material to withstand applied loads. A number of different laboratory techniques may be used to measure the Young's modulus of a treatment fluid including the cementitious composition after the treatment fluid has been allowed to set for a period of time at specified temperature and pressure conditions.

In embodiments, the cementitious composition has a ratio of the 7-day tensile strength (TS) to the 7-day YM of from about 30 psi/GPa to about 75 psi/GPa at from about 20° C./68° F. to about 150° C./302° F. when measured in accordance with test standard ASTM D3967-16, alternatively from about 30 psi/GPa to about 70 psi/GPa, alternatively from about 35 psi/GPa to about 65 psi/GPa, or alternatively from about 35 psi/GPa to about 60 psi/GPa.

In embodiments, the cementitious composition has a ratio of the 7-day unconfined compressive strength (UCS) to the 7-day YM of from about 200 psi/GPa to about 500 psi/GPa at from about 68° F. to about 302° F. when measured in accordance with test standard ASTM D7012-14e1, alternatively from about 200 psi/GPa to about 480 psi/GPa, alternatively from about 240 psi/GPa to about 480 psi/GPa, or alternatively from about 280 psi/GPa to about 450 psi/GPa.

In embodiments, after setting, the cementitious composition has a permeability measured in a Hassler type core holder in accordance with test standard API-RP-10B-2. Permeability is a measure of the amount of water or other substances that can penetrate through the composition after setting. The set cementitious composition can have a permeability equal to or less than about 30 micro Darcy (μD), alternatively equal to or less than about 10 μD, alternatively equal to or less than about 6 μD, or alternatively equal to or less than about 5 μD.

28-day permeability is the permeability measured after 28 days from preparation of the composition. In embodiments, the cementitious composition has a 28-day permeability of equal to or less than about 30 μD (micro Darcy) at from about 20° C./68° F. to about 80° C./176° F. when measured in a Hassler type core holder in accordance with test standard API-RP-10B-2, alternatively equal to or less than about 20 μD, alternatively equal to or less than about 10 μD, alternatively equal to or less than about 5 μD, alternatively equal to or less than about 4 μD, alternatively equal to or less than about 3 μD, alternatively equal to or less than about 2 μD, alternatively equal to or less than about 1 μD, or alternatively equal to or less than about 0.1 μD.

In embodiments, the cementitious composition has a 28-day permeability of equal to or less than about 30 μD at from about 80° C./176° F. to about 150° C./302° F. when measured in a Hassler type core holder in accordance with test standard API-RP-10B-2, alternatively equal to or less than about 10 μD, alternatively equal to or less than about 5 μD, alternatively equal to or less than about 3 μD, alternatively equal to or less than about 2 μD, alternatively equal to or less than about 1 μD, or alternatively equal to or less than about 0.1 μD. In embodiments, the set cement has a permeability of from about 0.01 μD to about 30 μD, alternatively from about 0.01 μD to about 10 μD, or alternatively from about 0.01 μD to about 6 μD.

In embodiments, the cementitious composition has a yield corrected carbon footprint, also referred to as yield corrected CO₂ footprint, of equal to or less than about 800 kilograms of equivalent CO₂ per cubic meter of the cementitious composition (kg/m³), alternatively equal to or less than about 750 kg/m³, alternatively equal to or less than about 700 kg/m³, alternatively equal to or less than about 650 kg/m³, alternatively equal to or less than about 600 kg/m³, alternatively equal to or less than about 550 kg/m³, alternatively equal to or less than about 500 kg/m³, or alternatively equal to or less than about 450 kg/m³.

Carbon footprint, which refers to carbon emissions due to a material, can be determined by a cradle to grave lifecycle analysis of the material. Cradle to grave includes emissions related to production, transportation, storage, usage and disposal stages of a material. Total emissions associated with a material is the sum of emissions in each phase. Emissions can be expressed as kilograms of equivalent CO₂ per unit mass (or volume) of the material. There are several standards for computing the carbon emissions of a material. For example, the United States Environmental Protection Agency (EPA) publishes standards listed in the EPA's Waste Reduction Model (WARM) which allows for calculation of the carbon emissions of a material. Another source of standard is the California Air Resources Board's greenhouse gas quantification methodology. The present disclosure uses data from certain suppliers of each component for calculating carbon footprint for materials. Where available, Environmental Product Declarations (EPD) certificates have been used. In embodiments, a dry blend comprises the cement blend (e.g., the cementitious material, pozzolan, and aplite) and other solid components of the composition. The carbon footprint of a dry blend is calculated using Equation (1) as below:

$$Carbon footprint = {\sum }_{k = 1}^{n} {( carbon footprint )}_{k} \cdot {x}_{k} \qquad ( 1 )$$

wherein the dry blend comprises n components, wherein (carbon footprint)ₖ is the carbon footprint of pure component k, and xx is the concentration of component k in the dry blend. The yield corrected carbon footprint is an estimate of carbon footprint per volume pumped for a cement slurry (e.g., the composition). A yield value of an example design of the composition can be used to calculate the consumption of the dry blend per given unit volume of the cement slurry (e.g., the composition) mixed to calculate the yield corrected carbon footprint. For example, if the yield value for a given composition (or a cement slurry) is 106 liter/100 kg, the corresponding blend requirement for 1 m³ of the example composition will be 943 kg. Hence the yield correction factor for the composition's (or slurry's) CO₂ footprint is 0.943 versus the dry blend's CO₂ footprint when contribution from any liquid additives is ignored.

In embodiments, the cementitious composition is capable to withstand a temperature in a range of from about 0° C./32° F. to about 204° C./400° F., alternatively from about 0° C./32° F. to about 180° C./356° F., alternatively from about 0° C./32° F. to about 150° C./302° F. In embodiments, the cementitious composition is used at temperature in a range of from about 50° F. (10° C.) to about 400° F. (204° C.), alternatively from about 50° F. (10° C.) to about 356° F. (180° C.), alternatively from about 50° F. (10° C.) to about 302° F. (150° C.).

A cementitious composition of the type disclosed herein can be prepared using any suitable method. In embodiments, the method comprises mixing components (e.g., Portland cement, Trass flour, LSC, aqueous fluid) of the cementitious composition using mixing equipment (e.g., a batch mixer, a jet mixer, a re-circulating mixer, a blender, a mixing head of a solid feeding system). Mixing the components of the cementitious composition can comprise one or more steps. For example, mixing the components of the cementitious composition can comprise dry mixing components of the cement blend and optional other solid components (e.g., a weighting agent) to form a dry blend, and mixing the dry blend with the LSC and the aqueous fluid or a mixture thereof and optional other additives to form a pumpable slurry (e.g., a homogeneous fluid). Any container(s) that is compatible with the components and has sufficient space can be used for mixing.

In embodiments, mixing the components of the cementitious composition can be on-the-fly (e.g., in real time or on-location). The cementitious composition can be used as a wellbore servicing fluid and be prepared at a wellsite. For example, the components of the cement blend (e.g., Portland cement, Trass flour) can be transported to the wellsite and combined (e.g., mixed/blended) with the LSC and the aqueous fluid or a blend of the liquid components located proximate the wellsite to form the cementitious composition. The aqueous fluid can be conveyed from a source to the wellsite or be available at the wellsite prior to the combining. The cement blend can be prepared at a location remote from the wellsite and transported to the wellsite, and, if necessary, stored at the on-site location. When it is desirable to prepare the cementitious composition at the wellsite, the components of the cement blend along with the LSC and additional aqueous fluid, and optional other additives can be mixed to form a mixture (e.g. in a blender tub, for example mounted on a trailer). Additives can be added to the cementitious composition during preparation thereof (e.g., during mixing) and/or on-the-fly (e.g., in real time or on-location) by addition to (e.g., injection into) the cementitious composition when being pumped into the wellbore.

The method disclosed herein can further comprise introducing the cementitious composition into a subterranean formation, and allowing at least a portion of the cementitious composition to set. In embodiments, introducing the cementitious composition into the subterranean formation uses one or more pumps.

A cementitious composition of the type disclosed herein can be used as a cementitious fluid. A cementitious fluid refers to a material that can set and be used to permanently seal an annular space between casing and a wellbore wall. A cementitious fluid can also be used to seal formations to prevent loss of drilling fluid (e.g., in squeeze cementing operations) and for operations ranging from setting kick-off plugs to plug and abandonment of a wellbore. Generally, a cementitious fluid used in oil field is pumpable in relatively narrow annulus over long distances. Disclosed herein is a method of servicing a wellbore penetrating a subterranean formation. In embodiments, the method comprises placing a cementitious composition disclosed herein into the wellbore.

In embodiments, the cementitious composition is used in a subterranean workspace, for example in cementing underground pipe such as sewer pipe or wellbore casing. In embodiments, the cementitious composition is employed in primary cementing of a wellbore for the recovery of natural resources such as water or hydrocarbons. Primary cementing first involves drilling a wellbore to a desired depth such that the wellbore penetrates a subterranean formation while circulating a drilling fluid through the wellbore. Subsequent to drilling the wellbore, at least one conduit such as a casing may be placed in the wellbore while leaving a space known as the annulus (i.e., annular space) between the wall of the conduit and the wall of the wellbore. The drilling fluid may then be displaced down through the conduit and up through the annulus one or more times, for example, twice, to clean out the hole. The cementitious composition can then be conveyed (e.g., pumped) downhole and up through the annulus, thereby displacing the drilling fluid from the wellbore. In embodiments, the cementitious composition sets into a hard mass, which forms a cement column that isolates an adjacent portion of the subterranean formation and provides support to the adjacent conduit.

In some other embodiments, the cementitious composition is employed in a secondary cementing operation such as squeeze cementing, which is performed after the primary cementing operation. In squeeze cementing, the cementitious composition can be forced under pressure into permeable zones through which fluid can undesirably migrate in the wellbore. Examples of such permeable zones include fissures, cracks, fractures, streaks, flow channels, voids, high permeability streaks, annular voids, or combinations thereof. The permeable zones can be present in the cement column residing in the annulus, a wall of the conduit in the wellbore, a micro annulus between the cement column and the subterranean formation, and/or a micro annulus between the cement column and the conduit. The cementitious composition can set within the permeable zones, thereby forming a hard mass to plug those zones and prevent fluid from leaking therethrough.

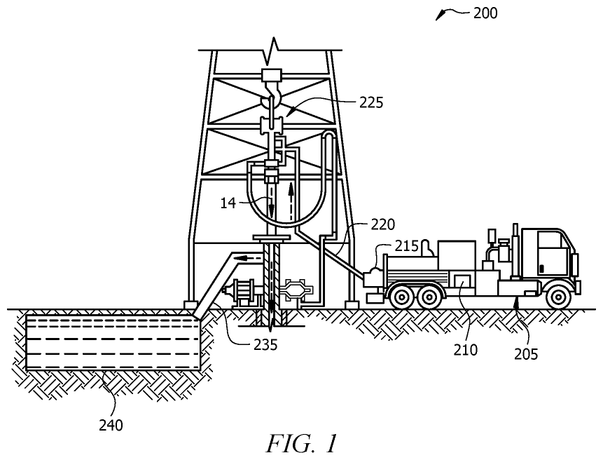

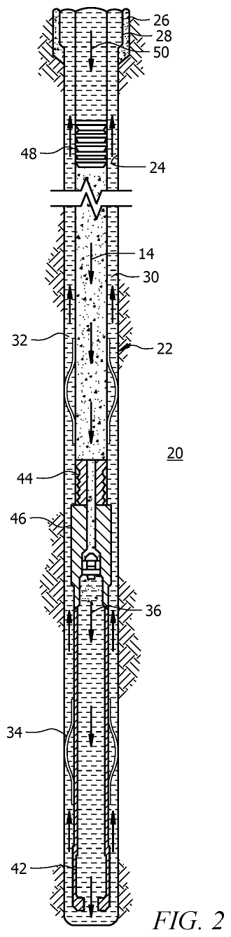

A cementitious composition of the type disclosed herein can be prepared using any suitable equipment or method. An example primary cementing technique using a cementitious composition will now be described with reference to FIGS. 1 and 2. FIG. 1 illustrates surface equipment 200 that can be used in the placement of a cementitious composition in accordance with certain examples. It will be noted that while FIG. 1 generally depicts a land-based operation, the principles described herein are equally applicable to subsea operations that employ floating or sea-based platforms and rigs, without departing from the scope of the disclosure. As illustrated by FIG. 1, the surface equipment 200 can include a cementing unit 205, which can include one or more cement trucks. The cementing unit 205 can include mixing equipment 210 and pumping equipment 215. Cementing unit 205, or multiple cementing units 205, can pump a cementitious composition 14 of the type disclosed herein through a feed pipe 220 and to a cementing head 225 which conveys the cementitious composition 14 downhole. Cementitious composition 14 can displace other fluids present in the wellbore, such as drilling fluids and spacer fluids, which can exit the wellbore through an annulus and flow through pipe 235 to mud pit 240.

As shown in FIG. 1, the cementitious composition may be mixed in mixing equipment 210, such as a jet mixer, re-circulating mixer, or a batch mixer, for example, and then pumped via pumping equipment 215 to the wellbore 22 (described hereinbelow with reference to FIG. 2). As depicted, in embodiments, the mixing equipment 210 and the pumping equipment 215 may be disposed on one or more cement trucks 205. In embodiments, a jet mixer may be used, for example, to continuously mix components of the cementitious composition (e.g., a (cementitious material, a pozzolanic material, aplite, LSC, an aqueous fluid) as it is being pumped to the wellbore 22. In embodiments, a re-circulating mixer and/or a batch mixer may be used to mix components of the cementitious composition (e.g., the dry blend, the one or more additives, the aqueous fluid), and the LSC may be added to the mixer 210 prior to pumping the cementitious composition downhole. Additionally, batch mixer type units for the cementitious composition may be plumbed in line with a separate tank containing the LSC. The LSC may then be fed in-line with the cementitious composition as it is pumped out of the mixing unit.

Referring to FIG. 2, the cementitious composition 14 can be placed into a subterranean formation 20 in accordance with example embodiments. As illustrated, a wellbore 22 can be drilled into the subterranean formation 20. While wellbore 22 is shown extending generally vertically into the subterranean formation 20, the principles described herein are also applicable to wellbores that extend at an angle through the subterranean formation 20, such as horizontal and slanted wellbores. As illustrated, the wellbore 22 comprises walls 24 of the wellbore 22. In the illustrated embodiment, a surface casing 26 has been inserted into the wellbore 22. The surface casing 26 can be cemented to the walls 24 of the wellbore 22 by cement sheath 28. In the illustrated embodiment, one or more additional conduits (e.g., intermediate casing, production casing, liners, etc.), shown here as casing 30 can also be disposed in the wellbore 22. As illustrated, there is a wellbore annulus (i.e., annular space) 32 formed between the casing 30 and the walls 24 of the wellbore 22 and/or the surface casing 26. One or more centralizers 34 can be attached to the casing 30, for example, to centralize the casing 30 in the wellbore 22 prior to and during the cementing operation.

With continued reference to FIG. 2, the cementitious composition 14 can be placed (e.g., pumped) down the interior of the casing 30. The composition 14 can be allowed to flow down the interior of the casing 30 through the casing shoe 42 at the bottom of the casing 30 and up around the casing 30 into the wellbore annulus 32. The cementitious composition 14 can be allowed to set in the wellbore annulus 32, for example, to form a cement sheath that supports and positions the casing 30 in the wellbore 22. Other techniques can also be utilized for introduction of the cementitious composition 14. By way of example, reverse circulation techniques can be used that includes introducing the cementitious composition 14 into the subterranean formation 20 by way of the wellbore annulus 32 instead of through the casing 30. In such embodiments, the method comprises circulating the cementitious composition 14 down through the wellbore annulus 32 and back up through the interior of the casing 30.

In embodiments, the cementitious composition 14 displaces other fluids 36, such as drilling fluids and/or spacer fluids that can be present in the interior of the casing 30 and/or the wellbore annulus 32. At least a portion of the displaced fluids 36 can exit the wellbore annulus 32 via a flow line and be deposited, for example, in one or more retention pits (e.g., a mud pit 240 in FIG. 1). A bottom plug 44 can be introduced into the wellbore 22 ahead of the cementitious composition 14, for example, to separate the cementitious composition 14 from the fluids 36 that can be inside the casing 30 prior to cementing. After the bottom plug 44 reaches the landing collar 46, a diaphragm or other suitable device can rupture to allow the cementitious composition 14 through the bottom plug 44. In FIG. 2, the bottom plug 44 is shown on the landing collar 46. In the illustrated embodiment, a top plug 48 can be introduced into the wellbore 22 behind the composition 14. The top plug 48 can separate the composition 14 from a displacement fluid 50 and also push the cementitious composition 14 through the bottom plug 44.

In embodiments, the method disclosed herein further comprises circulating the cementitious composition down through a conduit (e.g., casing) and back up through an annular space (also referred to as an annulus or a wellbore annulus) between an outside wall of the conduit and a wall of the wellbore. In some other embodiments, the method disclosed herein further comprises circulating the cementitious composition down through an annular space between an outside wall of a conduit and a wall of the wellbore and back up through the conduit. The method can further comprise allowing the cementitious composition to form a set cement. In embodiments, the set cement has a positive expansion. In other words, the set cement does not shrink in volume. An expansion of the set cement can be from 0 to about 10%, alternatively from 0 to about 5%, alternatively from 0 to about 2%, alternatively from 0 to about 1%, or alternatively from 0 to about 0.5%.

Disclosed herein is a method of servicing a wellbore penetrating a subterranean formation. The method can comprise placing a cementitious composition of the type disclosed herein into the wellbore, and allowing at least a portion of the cementitious composition to set. Also disclosed herein is a method of servicing a wellbore with a conduit (e.g., casing, production tubing, tubular, or other mechanical conveyance, etc.) disposed therein to form an annular space between a wellbore wall and an outer surface of the conduit. In embodiments, the method comprises placing a cementitious composition of the type disclosed herein into at least a portion of the annular space, and allowing at least a portion of the cementitious composition to set.

In the method disclosed herein, placing a cementitious composition into at least a portion of the annular space can be in different directions. In embodiments, placing the cementitious composition comprises circulating the cementitious composition down through the conduit and back up through the annular space. In some other embodiments, placing the cementitious composition comprises circulating the composition down through the annular space and back up through the conduit. In embodiments, the conduit comprises casing.

Various benefits may be realized by utilization of the presently disclosed methods and compositions. The cementitious composition as disclosed herein can develop suitable mechanical properties and permeability after setting and can, in embodiments, have a relatively low carbon footprint. The cementitious composition can also be expansive and thus avoid forming flow channels after setting of the cementitious composition.

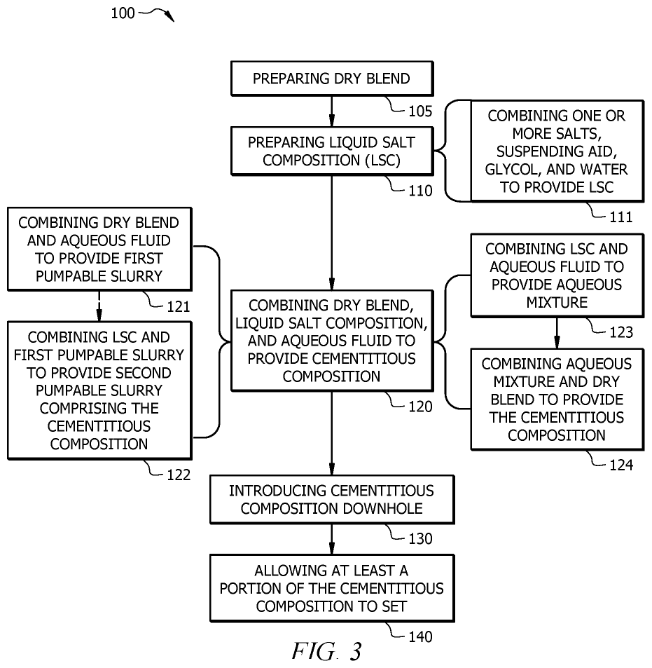

FIG. 3 illustrates a flow chart of a method 100 according to embodiments in the present disclosure. In embodiments, the method 100 comprises block 105, which comprises preparing a dry blend of the cementitious composition. The method 100 can further comprise preparing a liquid salt composition (LSC) of this disclosure at block 110. As depicted at block 111, preparing the liquid salt composition (LSC) can comprise combining the one or more salts, the suspending aid, the glycol, and the water to provide the LSC. Mixing equipment (e.g., a blender or mixer) can be used for mixing the components of the LSC.

Method 100 can further comprise, as depicted at block 120, combining the components of the cementitious composition to provide the cementitious composition as a pumpable slurry. Combining the components can comprise combining the dry blend (e.g., a dry blend comprising the dry components of the cementitious composition, such as a cementitious material, a pozzolanic material, and aplite), the LSC, and an aqueous fluid to provide the cementitious composition. As depicted in FIG. 3, combining components of the cementitious composition can comprise combining a dry blend and aqueous fluid to provide a first pumpable slurry at 121 and subsequently combining the first pumpable slurry obtained at 121 with the LSC at 122 to provide the cementitious composition. The first pumpable slurry herein can comprise the cementitious composition absent the LSC. Alternatively or additionally, combining the components of the cementitious composition can comprise combining the LSC and aqueous fluid at 123 to provide an aqueous mixture and subsequently combining the aqueous mixture and dry blend at 124 to provide the cementitious composition. Other sequences of combination of the components of the cementitious slurry are within the scope of this disclosure.

Thus, in embodiments, the method 100 can comprise placing components of the cementitious composition absent the LSC into a container (e.g., a mixer, a blender) at 121. The container can be any container that is compatible with the components and has sufficient space for the components. The method 100 can further comprise block 105, in which the dry blend and optionally other solid components (e.g., a weighting agent) of the cementitious composition can be dry mixed. Dry-mixing equipment (e.g., a mixing head of a solid feeding system, a dry-mixing container) can be used for dry mixing at 105. The dry-mixing container can be any container that is compatible with the components of the cementitious composition and optional other solid components and provides sufficient space. A blender can be used for dry mixing.

In embodiments, the method 100 comprises block 110, which comprises preparing an LSC using the method disclosed in the present disclosure. Block 110 can be prior to, concomitant with, or after block 105.

In embodiments, the method 100 further comprises block 122, which comprises blending the first pumpable slurry with the LSC to form a second pumpable slurry (e.g., a homogeneous fluid). The second pumpable slurry herein can comprise the cementitious composition. A blender or mixer can be used for blending/mixing. The density of the liquid salt composition can be similar to the density of the first pumpable slurry. In embodiments, the density of the LSC is from about 70% to about 120% of the density of the first pumpable slurry, alternatively from about 80% to about 100%, or alternatively from about 80% to about 95%. The specific gravity of the LSC can be in a range of from about 1 to about 2, from about 1.1 to about 2, or from about 1.25 to about 1.95, in embodiments.

In embodiments, the method 100 further comprises block 123 in which the LSC is combined with aqueous fluid to provide an aqueous mixture, and then block 124, at which the aqueous mixture is combined with the dry blend (and other optional components) to provide the cementitious composition.

In embodiments, the method 100 further comprises block 130, which comprises placing or introducing the cementitious composition into a wellbore. The method 100 can further comprise block 140, which comprises allowing at least a portion of the cementitious composition to set.

The cementitious composition can be prepared at any suitable location(s). Any step in the method of preparation can be at a location(s) remote from a wellsite or at a wellsite. With continued reference to FIG. 3, in embodiments, block 120 can be at a location remote from a wellsite. Block 110 can be at the same location as block 120, or a different remote location from a wellsite. In embodiments, the method 100 can further comprise transporting the dry blend, first pumpable slurry, the LSC, or a combination thereof to the wellsite, prior to block 120. The dry blend, first pumpable slurry, the liquid salt composition, or a combination thereof can be stored in container(s) before being transported to the wellsite. Step(s) in block 120 can be at the wellsite. In embodiments, the liquid salt composition operates as an activator and/or accelerator (e.g., to activate and/or accelerate the setting of the cementitious composition) to the cementitious composition (e.g., to a first pumpable slurry). In such embodiments, after blending with the LSC and/or aqueous fluid, setting of the cementitious slurry can be activated and/or accelerated and the cementitious composition can be ready for use in a wellbore. In embodiments, the wellsite is offshore. An offshore wellsite can have limited space, for example for storage of the dry blend, first pumpable slurry, and/or the LSC, and for blending the components of the cementitious composition.

Disclosed herein is a method of preparing a cementitious composition of the type disclosed herein, comprising: (a) mixing components of a dry blend of the cementitious composition using dry mixing equipment; (b) preparing an LSC of the type disclosed herein, wherein (a), (b), or both (a) and (b) are at a location(s) remote from a wellsite; (c) transporting the dry blend, the LSC, or both to the wellsite; and (d) blending the dry blend with the LSC and aqueous fluid to form a pumpable slurry of the cementitious composition at the wellsite.

While the preceding may describe the use of the LSC for use with a particular cementitious composition, it is to be understood that the LSC may be used in other cement compositions comprising a cementitious material and an aqueous fluid to accelerate or delay the set time of the cement composition and/or to enhance or reduce the development of early compressive strength. As such, the LSCs of the type disclosed herein are not limited by the term “accelerator” and can be referred to additionally or alternatively as liquid salt additive, liquid salt activator, liquid salt accelerator, liquid salt retarder, and the like, for example dependent upon the function of the liquid salt composition in a given cement composition as can be readily determined by a person of ordinary skill in the art (for example by comparing setting characteristics of a given cement composition in the presence and absence of a particular liquid salt composition). In embodiments, the liquid salt composition may be used in a cement composition comprising a pozzolan and an aqueous fluid. In embodiments, the liquid salt composition may be used in a cement composition comprising Portland cement and an aqueous fluid. In embodiments, the cement composition may further comprise one or more additives, such as those described above. The disclosure of the liquid salt composition used herein is not to be limited to particular cementitious composition detailed herein but may be used for any cement composition.

Also, the cementitious composition is one example of cementitious compositions, and the disclosed methods of preparing the cementitious composition described herein can be applied for preparing other cementitious compositions. The cementitious composition can comprise a cementitious material, an aqueous fluid, and the liquid salt composition (LSC) The cementitious material can comprise Portland cement, pozzolanic cement, gypsum cement, shale cement, acid/base cement, phosphate cement, high alumina content cement, slag cement, silica cement, high alkalinity cement, magnesia cement such as Sorel cements, fly ash cement, zeolite cement systems, cement kiln dust cement systems, slag cements, micro-fine cement, metakaolin, other settable materials, or combinations thereof. In embodiments, “high alkalinity cement” refers to a cement having a sodium oxide concentration in the range of from about 1.0 wt % to about 2.0 wt % by a weight of the high alkalinity cement. Shale cement refers to a cementitious material made from ground and burned shale.

In embodiments, the liquid salt composition operates as a retarder when incorporated in the cementitious composition. Referring to FIG. 3, block 122 can be at a location remote from a wellsite, in embodiments. In such embodiments, the method 100 can further comprise transporting the cementitious composition (e.g., the second pumpable slurry) to the wellsite, prior to block 130.

In embodiments, a liquid salt composition of the type disclosed herein can be a component of a multiphasic salt system (e.g., a multiphasic salt solution and suspension combination). In embodiments, a multiphasic salt system (e.g., a suspension or slurry) comprises any of the liquid salt composition disclosed herein suspended in a saturated salt solution. In embodiments, a multiphasic salt system (e.g., a suspension or slurry) comprises (i) a liquid salt composition comprising one or more salts, a suspending aid, glycol, and water, wherein the one or more salts are present in the liquid salt composition in an amount of from about 5 wt % to about 95 wt %, based on the total weight of the liquid salt composition (ii) suspended in a saturated salt solution. The saturated salt solution used to form a multiphasic salt system can be a saturated aqueous solution comprising any suitable salt including without limitation monovalent salts such as sodium chloride; divalent salts such as calcium chloride; or any combination thereof in an amount effect to yield a saturated aqueous solution. The monovalent salt may be any salt that dissociates to form a monovalent cation, such as sodium and potassium salts. Specific examples of suitable monovalent salts include potassium sulfate and sodium sulfate. In embodiments, the multiphasic salt system can be used in addition to or as an alternative to any of the uses of the liquid salt compositions disclosed herein (e.g., in addition to or as an alternative to a liquid salt composition of the type disclosed herein used to accelerate setting of the cementitious composition comprising the LSC).

As noted herein, conventional accelerators are considered total accelerators. Such conventional accelerators can be provided in solid form. They (a) reduce thickening time and (b) increase early compressive strength development after set. The herein disclosed liquid salt composition can be utilized, in applications, to increase early cement strength, and/or boost the growth of strength, without significantly altering thickening time.

Various benefits may be realized by utilization of the presently disclosed methods and compositions. By incorporating a suspending aid as disclosed herein, the liquid salt composition can include an increased concentration of salt, thus the liquid salt composition can be added into a cement slurry in a reduced volume, which can improve blending of the liquid salt composition and a cement slurry, eliminate a need for new higher capacity equipment, and can potentially save space in storage and transportation.

In applications, the LSC of this disclosure can be utilized as a supplementary product to established low CO₂ footprint materials (e.g., NeoCem™ E+ NS LT50 cement system, as discussed further in the Examples below). For example, in embodiments, early compressive strength can be improved by up to 40 to 50% or more by adding the LSC to the low CO₂ cement blend. This can reduce waiting on cement (WOC) time and in turn save rig time.

In applications, the LSC of this disclosure can enable maximized productivity, and allow for increased adoption of low CO₂ footprint solutions. The value added can be most significant at low temperatures, although benefits can be realized at higher temperatures.

In applications, the LSC of this disclosure can provide for the use of various components (e.g., salts) in new form. Salts (e.g., first and second salts) can be utilized in powder form in cement slurries by pre-blending or pre-hydrating in the mix fluid. This is however not practical on many offshore installations. Via this disclosure, salts conventionally introduced into cement slurries in powder form can be introduced in liquid form via the LSC of this disclosure, via the existing infrastructure on the installations. Liquid additives can be preferred because they are generally easier to handle offshore than powdered components, and existing mixing systems may be designed to deliver liquid admixtures only.

Also provided herein is a method for preparing an LSC comprising one or more salts in a stable suspension form and using the LSC in a composition (e.g., a cement slurry) as a strength accelerator.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

Liquid Salt Accelerator Stability Test. A liquid salt composition (LSC) according to this disclosure was prepared, as per the formulation of Table 1. The liquid salt accelerator comprised a suspension of a total of 800 kg/m³ (or 54% by wt.) salts.

TABLE 1
LSC formulation

| By wt % | Min | Max |
|---|---|---|
| Water | 0 | 94 |
| Monoethylene glycol | 0 | 94 |
| MgO | 0.01 | 1 |
| Clay | 0.5 | 10 |
| Biopolymer | 0.01 | 1 |
| Salt 1 | 2.5 | 47.5 |
| Salt 2 | 2.5 | 47.5 |
| Biocide | 0.01 | 0.5 |

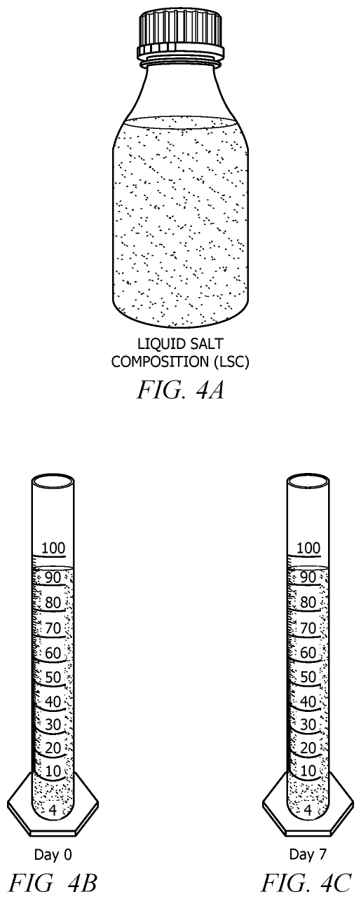

The LSC was kept on standing in a 100 mL measuring cylinder to observe the suspension stability. Results of this Example 1 are depicted in FIG. 4A, which depicts the suspension in a bottle, FIG. 4B, which depicts the LSC in the graduated cylinder on day 0 after placement in the graduated cylinder, and FIG. 4C, which depicts the LSC suspension in the graduated cylinder on day 7 of the stability test. As seen in FIGS. 4A-4C, there was no visible separation/floating of salts after 7 days, and the suspension was stable after standing in the 100 mL graduated cylinder for seven days. This Example 1 demonstrated a storage capability of the liquid salt composition.

### Example 2

The rheology profile of the LSC suspension of Example 1 was studied in this Example 2 by FANN35 using R1B5 rotor and bob combination. Rheologies were measured at 20° C./68° F. Table 2 shows the results of this investigation.

TABLE 2
LSC Rheology Profile

| RPM | 300 | 200 | 100 | 60 | 30 | 6 | 3 |
|---|---|---|---|---|---|---|---|
| Dial | 68 | 59 | 33 | 27 | 20 | 12 | 10 |
| Reading | | | | | | | |

The results of this Example 2 indicate that LSC is pourable and easy to transfer.

### Example 3

The specific gravity of the LSC suspension of Example 1 was studied in this Example 3. Table 3 shows the specific gravity (SG) of the LSC suspension across different portions of the suspension.

TABLE 3
SG Across Different Portions

| Section | SG |
|---|---|
| Top portion | 1.48 |
| Middle portion | 1.49 |
| Bottom portion | 1.50 |

The results of this Example 3 indicate that the LSC remained homogeneous throughout.

### Example 4

The physical properties of the LSC suspension of Example 1 are depicted in Table 4. Solid content was measured at 180° C./356° F. by using a moisture analyzer. Density was measured by pycnometer.

TABLE 4
Physical Properties of the LSC

| Form | Liquid |
|---|---|
| Appearance | White suspension |
| % Solids by weight | 56 |
| 6 rpm dial reading, R1B5 | 12 |
| Density, SG | 1.51 |
| Density, lbm/gal | 12.56 |

### Example 5

Reproducibility Study. In this Example 5, the reproducibility of 5 batches of LSC of Example 1 was studied. Specifically, five batches of the LSC were prepared as per Example 1, and the density, the 6 RPM and 100 rpm dial readings, and the percent total solids determined. The results are depicted in Table 5.

TABLE 5
Reproducibility Data - 5 Lab Batches

| | | | | | | | | Std |
|---|---|---|---|---|---|---|---|---|
| LSC | | | | | | | Std | Dev/ |
| Batch # | 1 | 2 | 3 | 4 | 5 | Average | Dev | Avg |
| Density, g/cm³ | 1.513 | 1.514 | 1.505 | 1.518 | 1.487 | 1.51 | 0.011 | 0.7% |
| Mix, 6 rpm on | 17 | 8 | 12 | 10 | 15 | 12 | 3 | 26.3% |
| R1B5 | | | | | | | | |
| Mix, 100 rpm on | 48 | 34 | 33 | 30 | 39 | 37 | 6 | 17.1% |
| R1B5 | | | | | | | | |
| % Total solids at | 56.0 | 56.8 | 56.0 | 55.5 | 55.9 | 56.0 | 0.4 | 0.7% |
| 180° C./356° F. | | | | | | | | |

The results of this Example 5 indicate that the LSC can be successfully reproduced.

### Example 6

In this Example 6, the performance of 1.70 SG cementitious compositions comprising NeoCem™ E+ NS LT50 cement system with and without the LSC of this disclosure (as described in Example 1) was studied. NeoCem™ E+ NS LT50 cement system is a reduced Portland cement system (e.g., a low CO₂ footprint cement blend) available from Halliburton AS Norway. The density of the cementitious slurry was measured using a pressurized mud balance. Thickening time was measured in consistometer in accordance with test standard API-RP-10B-2. The results of this Example 6 are depicted in Table 6.

TABLE 6
Performance Comparison in 1.70 SG (14.19 lbₘ/gal) Slurry Comprising
NeoCem ™ E + NS LT50 Cement System

| | | | |
|---|---|---|---|
| Description | Unit | Ref: No accelerator | With 1.25 lhk** LSC |

Additives

| | | | |
|---|---|---|---|
| Cement Blend | | NeoCem ™ E + NS | NeoCem ™ E + NS |
| | | LT50 | LT50 |
| Mix water | | Fresh water | Fresh water |
| CFR-8L | L/100 kg | 3.00 | 3.00 |
| LSC^{#} | L/100 kg | — | 1.25 |

Test conditions

| | | | |
|---|---|---|---|
| Density | SG | 1.70 | 1.70 |
| Density | lbm/gal | 14.19 | 14.19 |
| BHCT | ° F. | 59 | 59 |
| BHST | ° F. | 50 | 50 |
| Pressure | psi | 1000 | 1000 |
| Heating time | min | 10 | 10 |

Thickening time, UCA and Crush strength

| | | | |
|---|---|---|---|
| Thickening Time, 50Bc | hours | 8.9 | 5.6 |
| UCA 50 psi | hours | 14.0 | 10.8 |
| UCA 500 psi | hours | 39.2 | 28.6 |
| 24 hr UCA strength | psi | 219 | 381 |
| 24 hr Crush strength | psi | 74 | 361 |
| Std Dev, 24 hr Crush strength | psi | 6 | 1 |

Slurry properties

| | | | |
|---|---|---|---|
| Mixability | 0-5 | | |
| Mix, B1R1 300 rpm | ° | 47 | 52 |
| Mix, B1R1 3 rpm | ° | 12 | 17 |
| API, B1R1 300 rpm | ° | 57 | 85 |
| API, B1R1 3 rpm | ° | 12 | 22 |
| 10 min gel | ° | 23 | 28 |
| 30 min gel | ° | 29 | 47 |
| Free fluid, 0° inclination | % | 0.00 | 0.00 |
| SG top/bottom, 0° | SG/SG | 1.69/1.71 | 1.70/1.70 |

**lhk = liters per hundred kilograms
Note:
UCA and Crush strength cannot be compared as both are with different heating rates. UCA schedule - 59° F. in 1 hr, 1 hr hold and then 50° F. in next 22 hrs.
24 hr Crush strength started at 50° F. in refrigerator from the beginning.

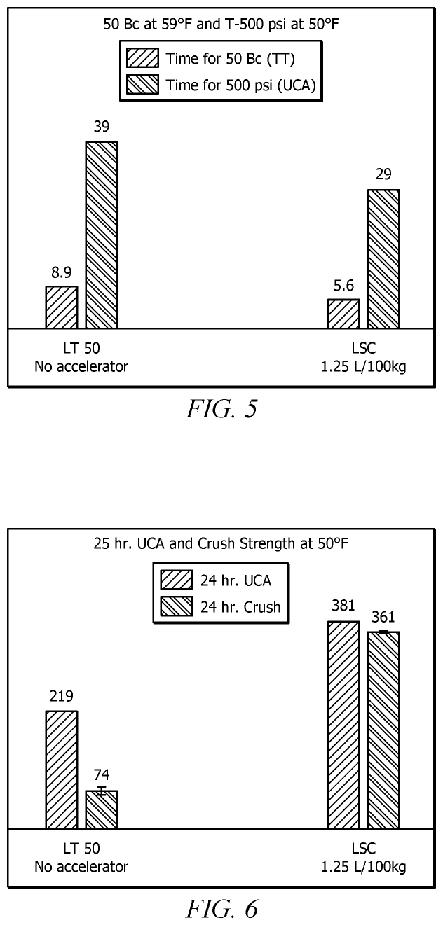

FIG. 5 is a plot of the data from this Example 6, showing the effect of accelerators on thickening time (TT) and time for 500 psi sonic strength in a 14.19 lbₘ/gal slurry comprising NeoCem™ E+ NS LT50 cement system. FIG. 6 is a plot using data from this Example 6, showing the effect of LSC on 24 hr strength (“24 hr UCA” and “24 hr Crush”) in the 14.19 lbₘ/gal NeoCem™ E+ NS LT50 cement system slurry.

### Example 7

In this Example 7, the performance and reproducibility of five samples of LSC of Example 5 was studied in the 13.35 lbm/gal NeoCem™ E+ NS LT50 cement system slurry. The results are depicted in Table 7.

TABLE 7
Performance comparison in 1.60 SG (13.35 lbm/gal) NeoCem ™ E+
NS LT50 cement system and reproducibility - 5 lab batches

| | | Comparative | | | | | |
|---|---|---|---|---|---|---|---|
| | | Example: | | | | | |
| Description | Unit | No LSC | #1 | #2 | #3 | #4 | #5 |

Additives

| | Cement Blend | | | | | | |
|---|---|---|---|---|---|---|---|
| | | NeoCem ™ | NeoCem ™ | NeoCem ™ | NeoCem ™ | NeoCem ™ | NeoCem ™ |
| | | E+ NS | E+ NS | E+ NS | E+ NS | E+ NS | E+ NS |
| | | LT50 | LT50 | LT50 | LT50 | LT50 | LT50 |
| | Mix water | | | | | | |
| | | Fresh | Fresh | Fresh | Fresh | Fresh | Fresh |
| | | water | water | water | water | water | water |
| LSC | L/100 kg | — | 1.25 | 1.25 | 1.25 | 1.25 | 1.25 |

Test conditions

| | | | | | | | |
|---|---|---|---|---|---|---|---|
| Density | SG | 1.60 | 1.60 | 1.60 | 1.60 | 1.60 | 1.60 |
| Density | lbm/gal | 13.35 | 13.35 | 13.35 | 13.35 | 13.35 | 13.35 |
| BHCT | ° F. | 59 | 59 | 59 | 59 | 59 | 59 |
| BHST | ° F. | 50 | 50 | 50 | 50 | 50 | 50 |
| Pressure | psi | 2000 | 2000 | 2000 | 2000 | 2000 | 2000 |
| Heating time | min | 10 | 10 | 10 | 10 | 10 | 10 |

Thickening time, UCA and Crush strength

| | | | | | | | |
|---|---|---|---|---|---|---|---|
| Thickening | hours | 4.8 | 5.0 | 5.2 | 4.3 | 4.3 | 5.1 |
| Time, 50 Bc | | | | | | | |
| UCA 50 psi | hours | 10.7 | 8.5 | 8.2 | 8.5 | 8.2 | 8.1 |
| UCA 500 psi | hours | 34.9 | 26.2 | 24.5 | 24.5 | 25.7 | 23.7 |
| 24 hr UCA | psi | 353 | 447 | 490 | 489 | 463 | 509 |
| strength | | | | | | | |
| 24 hr Crush | psi | 117 | 231 | 214 | 207 | 234 | 208 |
| strength | | | | | | | |
| Std Dev, | psi | 7 | 9 | 2 | 9 | 3 | 19 |
| 24 hr Crush | | | | | | | |
| strength | | | | | | | |

Slurry properties

| | | | | | | | |
|---|---|---|---|---|---|---|---|
| Mixability | 0-5 | 4 | 4 | 4 | 5 | 4 | 5 |
| Mix, B1R1 300 | ° | 58 | 60 | 75 | 54 | 55 | 73 |
| rpm | | | | | | | |
| Mix, B1R1 3 rpm | ° | 16 | 15 | 22 | 17 | 16 | 19 |
| API, B1R1 300 | ° | 77 | 79 | 75 | 75 | 72 | 80 |
| rpm | | | | | | | |
| API, B1R1 3 rpm | ° | 21 | 18 | 22 | 18 | 20 | 20 |
| 10 min gel | ° | 27 | 27 | 29 | 25 | 28 | 32 |
| 30 min gel | ° | 34 | 37 | 43 | 35 | 69 | 43 |
| Free fluid, 0° | % | 0.2 | 0.0 | 0.0 | 0.1 | 0.0 | 0.0 |
| inclination | | | | | | | |
| SG top/bottom, | SG/SG | 1.57/1.59 | 1.61/1.62 | 1.54/1.54 | 1.52/1.54 | 1.57/1.59 | 1.57/1.57 |
| 0° | | | | | | | |

Note:
UCA and Crush strength cannot be compared as both are with different heating rates.
UCA schedule - started at 68 F. and 24 hrs to 50° F.
24 hr Crush strength started at 50° F. in refrigerator from the beginning.

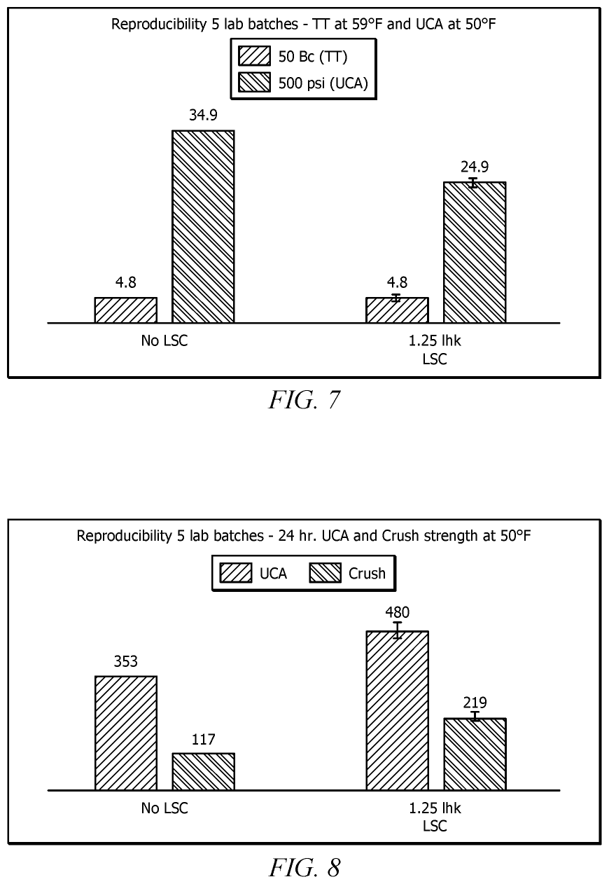

FIG. 7 is a plot of the data from this Example 7, showing thickening time (TT) and time for 500 psi sonic strength comparison in the 13.35 lbₘ/gal slurry comprising NeoCem™ E+ NS LT50 cement system. FIG. 8 is a plot using data from this Example 7, showing the UCA and crush strength comparison in the 13.35 lbm/gal NeoCem™ E+ NS LT50 cement system slurry. The results show that by incorporating LSC, the time for 500 psi is improved by ˜30% without compromising thickening time. Moreover, 24-hour sonic strength also increased by 35% and 24-hour crush strength increased by 85% compared to the Comparative Example without LSC.

### Example 8

In this Example 8, the effect of LSC concentration in a 1.60 SG NeoCem™ E+ NS LT50 cement system was studied. The results are depicted in Table 8.

TABLE 8
Effect of LSC Concentration in 1.60 SG (13.35 lbm/gal) NeoCem ™ E + NS LT50 Blend

| | | | | | |
|---|---|---|---|---|---|
| | | 0 1hk | 0.63 lhk | 1.25 lhk | 2.50 lhk |
| Description | Unit | LSC | LSC | LSC | LSC |

Additives

| | | | | | |
|---|---|---|---|---|---|
| Cement Blend | | NeoCem ™ | NeoCem ™ | NeoCem ™ | NeoCem ™ |
| | | E + NS | E + NS | E + NS | E + NS |
| | | LT50 | LT50 | LT50 | LT50 |
| Mix water | | Fresh | Fresh | Fresh | Fresh |
| | | water | water | water | water |
| LSC | L/100 kg | 0 | 0.63 | 1.25 | 2.50 |

Test conditions

| | | | | | |
|---|---|---|---|---|---|
| Density | SG | 1.60 | 1.60 | 1.60 | 1.60 |
| Density | lbm/gal | 13.35 | 13.35 | 13.35 | 13.35 |
| BHCT | ° F. | 59 | 59 | 59 | 59 |
| BHST | ° F. | 50 | 50 | 50 | 50 |
| Pressure | psi | 2000 | 2000 | 2000 | 2000 |
| Heating time | min | 10 | 10 | 10 | 10 |

Thickening time, UCA and Crush strength

| | | | | | |
|---|---|---|---|---|---|
| Thickening Time, 50Bc | hours | 4.8 | 4.6 | 5.0 | 5.6 |
| UCA 50 psi | hours | 10.7 | 8.9 | 8.5 | 7.3 |
| UCA 500 psi | hours | 34.9 | 33.9 | 26.2 | 21.9 |
| 24 hr UCA strength | psi | 353 | 405 | 447 | 566 |
| 24 hr Crush strength | psi | 117 | 199 | 231 | 303 |
| Std Dev, 24 hr Crush strength | psi | 7 | 2 | 9 | 8 |

Slurry properties

| | | | | | |
|---|---|---|---|---|---|
| Mixability | 0-5 | 4 | 5 | 4 | 4 |
| Mix, B1R1 300 rpm | ° | 58 | 53 | 60 | 53 |
| Mix, B1R1 3 rpm | ° | 16 | 14 | 15 | 15 |
| API, B1R1 300 rpm | ° | 77 | 72 | 79 | 73 |
| API, B1R1 3 rpm | ° | 21 | 17 | 18 | 18 |
| 10 min gel | ° | 27 | 25 | 27 | 26 |
| 30 min gel | ° | 34 | 33 | 37 | 38 |
| Free fluid, 0° inclination | % | 0.2 | 0.3 | 0.0 | 0.0 |
| SG top/bottom, 0° | SG/SG | 1.57/1.59 | 1.59/1.59 | 1.61/1.62 | 1.55/1.57 |

Note:
UCA and Crush strength cannot be compared as both are with different heating rates. UCA schedule - 59° F. in 1 hr, then 50° F. in next 23 hrs.
24 hr Crush strength started at 50° F. in refrigerator from the beginning.

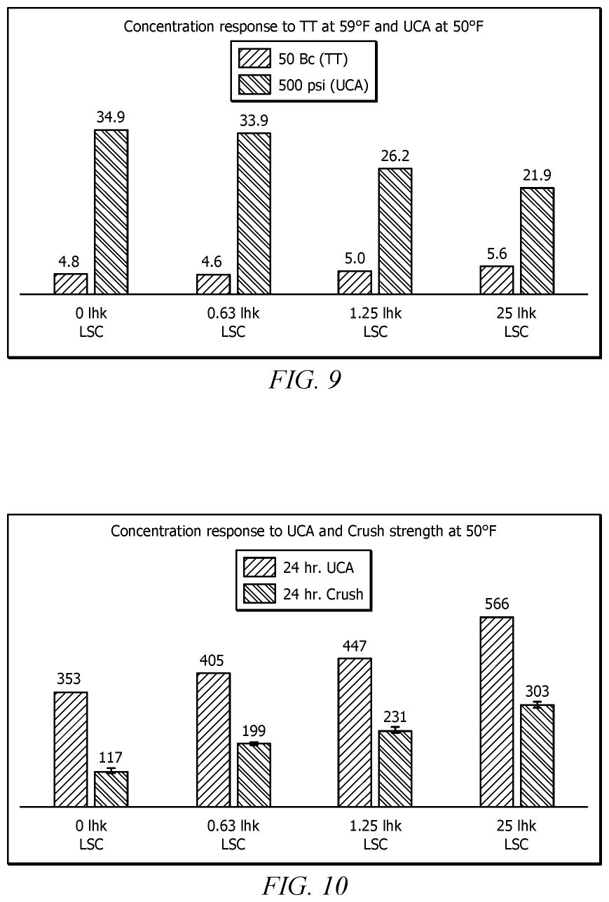

FIG. 9 is a plot of the data from this Example 8, showing the effect of the LSC concentration on the thickening time (TT) and time for 500 psi sonic strength in the 13.35 lbₘ/gal slurry comprising NeoCem™ E+ NS LT50 cement system. FIG. 10 is a plot using data from this Example 8, showing the effect of the LSC concentration on 24 hour strength (e.g., 24 hr UCA and 24 hr crush strength) in the 13.35 lbm/gal NeoCem™ E+ NS LT50 cement system slurry. The results show that time for 500 psi decreased, and strength increased with increase in LSC concentration.

### Example 9

In this Example 9, a performance comparison in 1.92 SG neat slurry with and one without the LSC of this disclosure was studied. This was an ordinary class G cement. The results are depicted in Table 9.

TABLE 9
Performance Comparison in 1.92 SG (16.02 lbm/gal) Neat Slurry

| | | | | |
|---|---|---|---|---|
| | | Ref: | 1 lhk | 1.25 lhk |
| Description | Unit | Neat slurry | LSC | LSC |

Additives

| | | | | |
|---|---|---|---|---|
| Cement-Dyckerhoff | | Dy. Cl. G | Dy. Cl. G | Dy. Cl. G |
| Class G | | | | |
| Mix water | | Fresh | Fresh | Fresh |
| | | water | water | water |
| LSC | L/100 kg | — | 1.00 | 1.25 |

Test conditions

| | | | | |
|---|---|---|---|---|
| Density | SG | 1.92 | 1.92 | 1.92 |
| Density | lbm/gal | 16.02 | 16.02 | 16.02 |
| BHCT | ° F. | 68 | 68 | 68 |
| BHST | ° F. | 68 | 68 | 68 |
| Pressure | psi | 2900 | 2900 | 2900 |
| Heating time | min | 60 | 60 | 60 |

Thickening time and UCA

| | | | | |
|---|---|---|---|---|
| Thickening Time, | hours | 6.9 | 4.1 | 4.5 |
| 50Bc | | | | |
| UCA 50 psi | hours | 8.8 | 7.2 | 7.0 |
| UCA 500 psi | hours | 19.3 | 14.1 | 13.8 |
| 24 hr UCA strength | psi | 781 | 1452 | 1498 |

The results show that addition of LSC shortened the thickening time and time for 500 psi by 38% and 28% respectively and improved 24-hour sonic strength by 90%.

### Additional Disclosure

The following is provided as additional disclosure for combinations of features and embodiments of the present disclosure.

In a first embodiment, a liquid salt composition for a cementitious slurry comprises one or more salts, a suspending aid, glycol, and water, wherein the one or more salts are present in the liquid salt composition in an amount of from about 5 wt % to about 95 wt %, based on the total weight of the liquid salt composition.

A second embodiment can include the liquid salt composition of the first embodiment, wherein the glycol comprises mono-ethylene glycol (MEG; also known as 1,2-ethanediol), monopropylene glycol (MPG; also known as 1,2-propanediol), dipropylene glycol (DPG); triethylene glycol (TEG); butylene glycol (also known as butanediol, e.g., 1,3-butylene glycol (1,3-butanediol) or 1,4-butylene glycol (1,4-butanediol)), or a combination thereof.

A third embodiment can include the liquid salt composition of the first or second embodiment, wherein the one or more salts comprises chloride, sulfate, phosphate, bromide, bicarbonate, acetate, formate, and/or carbonate salts of lithium, potassium, sodium, calcium, magnesium, zinc, and iron, or combinations thereof.

A fourth embodiment can include the liquid salt composition of any one of the first to third embodiments, wherein the one or more salts comprise sodium chloride and sodium sulfate.

A fifth embodiment can include the liquid salt composition of the fourth embodiment, wherein the weight ratio of sodium chloride to sodium sulfate is from about 1:9 to about 9:1.

A sixth embodiment can include the liquid salt composition of any one of the first to fifth embodiments, wherein the suspending aid comprises a synthetic polymer, a biopolymer, a clay, or a combination thereof.

A seventh embodiment can include the liquid salt composition of any one of the first to sixth embodiments, wherein the suspending aid comprises clay and a water-soluble polymer.

An eighth embodiment can include the liquid salt composition of any one of the first to seventh embodiments, wherein the suspending aid comprises Diutan gum, Welan gum, xanthan gum, guar gum, hydroxy ethyl cellulose, starch and combination thereof.

A ninth embodiment can include the liquid salt composition of any one of the first to eighth embodiments, wherein the suspending aid is present in the liquid salt composition in an amount of from about 0.05 wt % to about 20.0 wt %, based on the total weight of the liquid salt composition.

A tenth embodiment can include the liquid salt composition of any one of the first to ninth embodiments, wherein the water comprises water selected from the group consisting of fresh water, surface water, ground water, salt water, brine, sea water, produced water, and any combination thereof.

An eleventh embodiment can include the liquid salt composition of any one of the first to tenth embodiments, wherein the water is present in the liquid salt composition in an amount of from greater than 0 to about 95 wt %, based on the total weight of the liquid salt composition.

A twelfth embodiment can include the liquid salt composition of any one of the first to eleventh embodiments, wherein the glycol is present in the liquid salt composition in an amount of from 0 or greater than 0 to about 95 wt % based on the total weight of the liquid salt composition.

A thirteenth embodiment can include the liquid salt composition of any one of the first to twelfth embodiments, having a density of from about 9 lb/gal to about 20 lb/gal.

A fourteenth embodiment can include the liquid salt composition of any one of the first to thirteenth embodiments, having a free fluid in a range of from about 0 vol. % to about 10 vol. % based on the total volume of the liquid salt composition, after being static at about 70° F. for about 1 week to about seven weeks.

In a fifteenth embodiment, a cementitious composition comprises: a cementitious material, an aqueous fluid, and a liquid salt composition, wherein the liquid salt composition comprises one or more salts, a suspending aid, glycol, and water, wherein the one more salts are present in the liquid salt composition in an amount of from about 5 wt % to about 95 wt %, based on the total weight of the liquid salt composition.

A sixteenth embodiment can include the cementitious composition of the fifteenth embodiment, wherein the cementitious material comprises a hydraulic cement.

A seventeenth embodiment can include the cementitious composition of the sixteenth embodiment, wherein the hydraulic cement is selected from the group consisting of Portland cements, pozzolana cements, gypsum cements, high alumina content cements, silica cements, low CO2 cements, or combinations thereof.

An eighteenth embodiment can include the cementitious composition of any one of the fifteenth to seventeenth embodiments further comprising a supplementary cementitious material.

A nineteenth embodiment can include the cementitious composition of the eighteenth embodiment, wherein the supplementary cementitious material is selected from the group consisting of fly ash, blast furnace slag, silica fume, pozzolans, kiln dust, clays, volcanic ash, and combinations thereof.

A twentieth embodiment can include the cementitious composition of any one of the fifteenth to nineteenth embodiments, further comprising hydrated lime.

A twenty first embodiment can include the cementitious composition of any one of the fifteenth to twentieth embodiments, wherein the liquid salt composition is present in the composition in an amount of from about 0.001 wt % to about 50 wt %, based on the total weight of the composition.

In a twenty second embodiment, a cementitious composition comprises a dry blend comprising a cementitious material, the liquid salt composition of any of the first to fourteenth embodiments, and an aqueous fluid.

A twenty third embodiment can include the cementitious composition of the twenty second embodiment, wherein the liquid salt composition is present in the cementitious composition in an amount of from about 0.1% by weight of dry blend (bwob) to about 50% bwob, based on the total weight of the cementitious composition.

A twenty fourth embodiment can include a multiphasic salt system comprising a liquid salt composition, wherein the liquid salt composition comprises one or more salts, a suspending aid, glycol, and water, wherein the one more salts are present in the liquid salt composition in an amount of from about 5 wt % to about 95 wt %, based on the total weight of the liquid salt composition, and wherein the liquid salt composition is suspended in a saturated or over-saturated salt solution or suspension.

While embodiments of the disclosure have been shown and described, modifications thereof can be made by one skilled in the art without departing from the spirit and teachings of the disclosure. The embodiments described herein are exemplary only, and are not intended to be limiting. Many variations and modifications of the disclosure disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. When a feature is described as “optional,” both embodiments with this feature and embodiments without this feature are disclosed. Similarly, the present disclosure contemplates embodiments where this feature is required and embodiments where this feature is specifically excluded. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure.

What is claimed is:

1. A liquid salt composition for a cementitious slurry, the liquid salt composition comprising one or more salts, a suspending aid, glycol, and water, wherein the one or more salts are present in the liquid salt composition in an amount of from about 5 wt % to about 95 wt %, based on the total weight of the liquid salt composition.

2. The liquid salt composition of claim 1, wherein the glycol comprises mono-ethylene glycol (MEG), monopropylene glycol (MPG), dipropylene glycol (DPG); triethylene glycol (TEG); butylene glycol, or a combination thereof.

3. The liquid salt composition of claim 1, wherein the one or more salts comprises chloride, sulfate, phosphate, bromide, bicarbonate, acetate, formate, and/or carbonate salts of lithium, potassium, sodium, calcium, magnesium, zinc, and iron, or combinations thereof.

4. The liquid salt composition of claim 1, wherein the one or more salts comprise sodium chloride and sodium sulfate.

5. The liquid salt composition of claim 4, wherein the weight ratio of sodium chloride to sodium sulfate is from about 1:9 to about 9:1.

6. The liquid salt composition of claim 1, wherein the suspending aid comprises a synthetic polymer, a biopolymer, a clay, or a combination thereof.

7. The liquid salt composition of claim 1, wherein the suspending aid comprises clay and a water-soluble polymer.

8. The liquid salt composition of claim 1, wherein the suspending aid comprises Diutan gum, Welan gum, xanthan gum, guar gum, hydroxy ethyl cellulose, starch and combination thereof.

9. The liquid salt composition of claim 1, wherein the suspending aid is present in the liquid salt composition in an amount of from about 0.05 wt % to about 20.0 wt %, based on the total weight of the liquid salt composition.

10. The liquid salt composition of claim 1, wherein the water comprises water selected from the group consisting of fresh water, surface water, ground water, salt water, brine, sea water, produced water, and any combination thereof.

11. The liquid salt composition of claim 1, wherein the water is present in the liquid salt composition in an amount of from greater than 0 to about 95 wt %, based on the total weight of the liquid salt composition.

12. The liquid salt composition of claim 1, wherein the glycol is present in the liquid salt composition in an amount of from greater than 0 to about 95 wt % based on the total weight of the liquid salt composition.

13. The liquid salt composition of claim 1, having a density of from about 9 lb/gal to about 20 lb/gal.

14. The liquid salt composition of claim 1, having a free fluid in a range of from about 0 vol. % to about 10 vol. % based on the total volume of the liquid salt composition, after being static at about 70° F. for about 1 week to about seven weeks.

15. A cementitious composition comprising: a cementitious material, an aqueous fluid, and a liquid salt composition, wherein the liquid salt composition comprises one or more salts, a suspending aid, glycol, and water, wherein the one or more salts are present in the liquid salt composition in an amount of from about 5 wt % to about 95 wt %, based on the total weight of the liquid salt composition.

16. The cementitious composition of claim 15, wherein the cementitious material comprises a hydraulic cement.

17. The cementitious composition of claim 16, wherein the hydraulic cement is selected from the group consisting of Portland cements, pozzolana cements, gypsum cements, high alumina content cements, silica cements, low CO₂ cements, or combinations thereof.

18. The cementitious composition of claim 15, further comprising a supplementary cementitious material selected from the group consisting of fly ash, blast furnace slag, silica fume, pozzolans, kiln dust, clays, volcanic ash, and combinations thereof.

19. The cementitious composition of claim 15, wherein the liquid salt composition is present in the composition in an amount of from about 0.001 wt % to about 50 wt %, based on the total weight of the composition.

20. A multiphasic salt system comprising a liquid salt composition, wherein the liquid salt composition comprises one or more salts, a suspending aid, glycol, and water, wherein the one more salts are present in the liquid salt composition in an amount of from about 5 wt % to about 95 wt %, based on the total weight of the liquid salt composition, and wherein the liquid salt composition is suspended in a saturated or over-saturated salt solution or suspension.
